(19) United States
(12) Patent Application Publication
(10) Pub. No.: US 2026/0251449 A1
(43) Pub. Date: Aug. 27, 2026

(54) CONTROL CIRCUIT IN ULTRASONIC DETECTION DEVICE, CONVEYANCE DEVICE, AND IMAGE PROCESSING DEVICE

(71) Applicant: SEIKO EPSON CORPORATION, Tokyo (JP)

(72) Inventor: Seiji TAKAMATSU, KITAKYUSHU-SHI (JP)

(21) Appl. No.: 19/544,483

(22) Filed: Feb. 19, 2026

(30) Foreign Application Priority Data
Feb. 21, 2025 (JP) 2025-027151

(51) Int. Cl. G01B 17/02; B06B 1/06; H04N 1/00; H04N 1/12

(52) U.S. Cl. CPC G01B 17/02; B06B 1/06; H04N 1/00689; H04N 1/00692; H04N 1/00729; H04N 1/00745; H04N 1/1215; H04N 2201/0081

(57) ABSTRACT

A control circuit controls a power supply voltage to generate a DC voltage to be applied to an ultrasonic reception element. The control circuit includes a changeover switch that switches between a first voltage generation circuit configured to generate a first DC voltage equal to or lower than the power supply voltage and a second voltage generation circuit configured to generate a second DC voltage higher than the power supply voltage. The second voltage generation circuit includes a booster circuit that boosts the power supply voltage to the second DC voltage. The booster circuit includes a capacitor that accumulates charges for boosting when the second voltage generation circuit is effective. The power supply voltage is boosted to the second DC voltage using a potential difference between both sides of the capacitor.

The present application is based on, and claims priority from JP Application Serial Number 2025-027151, filed February 21, 2025, the disclosure of which is hereby incorporated by reference herein in its entirety.

### BACKGROUND

### Technical Field

The present disclosure relates to a control circuit in an ultrasonic detection device including an ultrasonic sensor, a conveyance device, and an image processing device.

### Related Art

For example, JP-A-2024-53210 discloses an ultrasonic device including an ultrasonic sensor. An image scanner reads an image of a document (an example of a medium) conveyed along a conveyance path by a conveyance device. The ultrasonic sensor detects, for example, multiple feeding of documents.

The ultrasonic sensor includes an ultrasonic transmission element that transmits an ultrasonic wave and an ultrasonic reception element that receives an ultrasonic wave. The ultrasonic reception element includes a vibration portion that can vibrate when the ultrasonic receives an ultrasonic wave and a piezoelectric element disposed at the vibration portion. The piezoelectric element is stacked on, for example, a vibration plate. The ultrasonic device includes a control unit that controls the ultrasonic reception element. The control unit detects multiple feeding of documents based on an intensity of an electric signal output from the piezoelectric element in response to the vibration of the vibration portion.

An ultrasonic detection device includes a power supply circuit (an example of a control circuit) that applies a DC voltage to the ultrasonic reception element. When the ultrasonic reception element receives an ultrasonic wave, the control unit drives the piezoelectric element in a reception drive mode in which a first DC voltage, which is obtained by applying an electric field having a first electric field intensity, is applied to a piezoelectric body. Before the execution of the reception drive mode, the control unit drives the piezoelectric element in a high electric field drive mode in which a second DC voltage, which is obtained by applying an electric field having a second electric field intensity higher than the first electric field intensity, is applied to the piezoelectric body. The control unit executes control to drive the piezoelectric element in the high electric field drive mode before the execution of the reception drive mode, and thus it is possible to reduce a decrease in sensitivity of the ultrasonic reception element.

JP-A-2024-53211 discloses an ultrasonic device similar to the device described in JP-A-2024-53210. A control unit controls a power supply circuit (an example of a control circuit) to drive a piezoelectric element in a reception drive mode in which a first DC voltage, which is obtained by applying an electric field having a first electric field intensity, is applied to a piezoelectric body after the elapse of a first time from the start of transmission of an ultrasonic wave by an ultrasonic transmission element. The control unit drives the piezoelectric element in a reverse electric field drive mode in which a second DC voltage, which is obtained by applying an electric field having a second electric field intensity lower than the first electric field intensity, is applied to the piezoelectric body after the elapse of a second time from the start of the reception drive mode. It is possible to reduce a decrease in sensitivity of an ultrasonic reception element over time from the start of the application of a reception drive voltage to the ultrasonic reception element.

JP-A-2024-53210 and JP-A-2024-53211 are examples of the related art.

However, in the ultrasonic device disclosed in JP-A-2024-53210, in order to generate the second DC voltage to be applied to the piezoelectric body in the high electric field drive mode, it is necessary to prepare a power supply that can supply a high power supply voltage equal to or higher than the second DC voltage. In the ultrasonic device disclosed in JP-A-2024-53211, in order to generate the second DC voltage to be applied to the piezoelectric body in the reverse electric field drive mode, it is necessary to prepare a power supply that can supply a power supply voltage lower than a reference voltage such as a ground voltage. Alternatively, it is necessary to provide a known booster circuit that boosts a power supply voltage supplied from a power supply or a known step-down circuit that steps down a reference voltage such as a ground voltage. Therefore, there are problems such as complication and high cost of a power supply circuit. Therefore, there is room for improvement in the configuration of a circuit that supplies a second DC voltage higher than a power supply voltage or a second DC voltage lower than a reference voltage such as a ground voltage with a simple circuit configuration.

### SUMMARY

In order to solve the above problems, a control circuit in an ultrasonic detection device is a control circuit that is provided in the ultrasonic detection device including an ultrasonic transmission element configured to transmit an ultrasonic wave and a piezoelectric ultrasonic reception element configured to receive an ultrasonic wave, and that controls a power supply voltage supplied from a power supply to switch a DC voltage to be applied to the ultrasonic reception element. The control circuit includes: a first voltage generation circuit configured to generate a first DC voltage equal to or lower than the power supply voltage; a second voltage generation circuit configured to generate a second DC voltage higher than the power supply voltage; and a changeover switch configured to switch one of the first voltage generation circuit and the second voltage generation circuit as an effective circuit that generates the DC voltage, in which the second voltage generation circuit includes a booster circuit that boosts the power supply voltage to the second DC voltage, and the booster circuit includes a capacitor that accumulates charges for boosting when the second voltage generation circuit is switched to be effective, and boosts the power supply voltage to the second DC voltage using a potential difference between both sides of the capacitor.

In order to solve the above problems, a control circuit in an ultrasonic detection device is a control circuit that is provided in the ultrasonic detection device including an ultrasonic transmission element configured to transmit an ultrasonic wave and a piezoelectric ultrasonic reception element configured to receive an ultrasonic wave, and that controls a power supply voltage supplied from a power supply to switch a DC voltage to be applied to the ultrasonic reception element. The control circuit includes: a first voltage generation circuit configured to generate a first DC voltage equal to or lower than the power supply voltage at a detection period when the ultrasonic reception element receives the ultrasonic wave; a second voltage generation circuit configured to generate a negative second DC voltage lower than a reference voltage of the power supply at a non-detection period when the ultrasonic reception element does not receive the ultrasonic wave; and a changeover switch configured to switch one of the first voltage generation circuit and the second voltage generation circuit as an effective circuit that generates the DC voltage, in which the second voltage generation circuit includes a step-down circuit that steps down the power supply voltage to the second DC voltage, and the step-down circuit includes a capacitor that accumulates charges for step-down when the second voltage generation circuit is switched to be effective, and steps down the reference voltage to the second DC voltage using a potential difference between both sides of the capacitor.

The ultrasonic detection device for solving the above problems includes the control circuit, the ultrasonic transmission element, and the ultrasonic reception element.

In order to solve the above problems, a conveyance device includes: the control circuit; a conveyance unit configured to convey a medium along a conveyance path; a control unit configured to control the control circuit and the conveyance unit; and an ultrasonic sensor including the ultrasonic transmission element and the ultrasonic reception element that are disposed to face each other across the conveyance path.

In order to solve the above problems, an image processing device may include: the conveyance device; an image processing unit configured to execute processing related to an image on the medium conveyed along the conveyance path; and a medium sensor provided upstream of the image processing unit in the conveyance path and configured to detect the medium conveyed along the conveyance path, in which the ultrasonic sensor may be located upstream of the medium sensor in the conveyance path.

In order to solve the above problems, an image processing device includes: the conveyance device; an image processing unit configured to execute processing related to an image on the medium conveyed along the conveyance path; a first medium sensor located upstream of the image processing unit in the conveyance path and configured to detect presence or absence of the medium; an ultrasonic sensor located upstream of the first medium sensor in the conveyance path and including the ultrasonic transmission element and the ultrasonic reception element that face each other across the conveyance path; and a second medium sensor located upstream of the ultrasonic sensor in the conveyance path and configured to detect presence or absence of the medium, in which the control unit is configured to cause the ultrasonic reception element to receive the ultrasonic wave in a reception drive mode in which the first DC voltage, which is obtained by applying an electric field of a first electric field intensity, is applied to the ultrasonic reception element when a detection result of the first medium sensor indicates the presence of the medium, and perform a reverse electric field drive mode in which the second DC voltage, which is obtained by applying an electric field in a direction reverse to a direction of the electric field in the reception drive mode to the ultrasonic reception element, is applied to the ultrasonic reception element when a detection result of the second medium sensor indicates the absence of the medium.

In order to solve the above problems, a voltage control method of an ultrasonic reception element is a voltage control method of controlling a power supply voltage supplied from a power supply to switch a DC voltage to be applied to the ultrasonic reception element in an ultrasonic detection device including an ultrasonic transmission element that transmits an ultrasonic wave and the ultrasonic reception element that receives an ultrasonic wave. The voltage control method of the ultrasonic reception element includes: (A1) generating a first DC voltage equal to or lower than the power supply voltage in a detection period in which the ultrasonic reception element receives the ultrasonic wave; and (A2) generating a second DC voltage higher than the power supply voltage in a non-detection period in which the ultrasonic reception element does not receive the ultrasonic wave, in which the generation of the second DC voltage includes (A21) generating a first rectangular wave having an amplitude equal to or lower than the power supply voltage, (A22) generating a second rectangular wave obtained by shifting up a voltage level of the first rectangular wave, and (A23) rectifying the second rectangular wave, and the shift-up is performed based on a potential difference caused by charges accumulated in a capacitor coupled between an input point that receives the first rectangular wave and an output point that outputs the second rectangular wave.

In order to solve the above problems, a voltage control method of an ultrasonic reception element is a voltage control method of controlling a power supply voltage supplied from a power supply to switch a DC voltage to be applied to the ultrasonic reception element in an ultrasonic detection device including an ultrasonic transmission element that transmits an ultrasonic wave and the ultrasonic reception element that receives an ultrasonic wave. The voltage control method of the ultrasonic reception element includes: (B1) generating a first DC voltage equal to or lower than the power supply voltage in a detection period in which the ultrasonic reception element receives the ultrasonic wave; and (B2) generating a negative second DC voltage lower than a reference voltage which is a low-potential-side voltage of the power supply in a non-detection period in which the ultrasonic reception element does not receive the ultrasonic wave, in which the generation of the second DC voltage includes (B21) generating a first rectangular wave having an amplitude equal to or lower than the power supply voltage, (B22) generating a second rectangular wave obtained by shifting down a voltage level of the first rectangular wave, and (B23) rectifying the second rectangular wave, and the shift-down is performed based on a potential difference caused by charges accumulated in a capacitor coupled between an input point that receives the first rectangular wave and an output point that outputs the second rectangular wave.

### BRIEF DESCRIPTION OF THE DRAWINGS

FIG. 1 is a perspective view showing an appearance of an image reading device according to a first embodiment.

FIG. 2 is a schematic cross-sectional view showing a schematic configuration of the image reading device including a multiple feed sensor.

FIG. 3 is a plan view showing an ultrasonic element substrate.

FIG. 4 is a cross-sectional view taken along a line 4-4 in FIG. 3.

FIG. 5 is a block diagram showing an electric configuration of the image reading device.

FIG. 6 is a timing chart showing transmission drive and reception drive.

FIG. 7 is a circuit diagram showing a control circuit for controlling a DC voltage applied to an ultrasonic reception element.

FIG. 8 is a timing chart showing a control signal, a power supply voltage, and an application voltage.

FIG. 9 is a graph showing a first rectangular wave and a second rectangular wave.

FIG. 10 is a timing chart showing transmission drive and reception drive according to a second embodiment.

FIG. 11 is a circuit diagram showing a control circuit for controlling a DC voltage applied to an ultrasonic reception element.

FIG. 12 is a timing chart showing a control signal, a power supply voltage, and a DC voltage.

FIG. 13 is a graph showing how a first DC voltage and a second DC voltage are generated.

FIG. 14 is a schematic cross-sectional view showing an image forming device including an ultrasonic sensor according to a modification.

FIG. 15 is a schematic cross-sectional view showing a part of an image reading device including an ultrasonic sensor according to a modification different from FIG. 14.

### DESCRIPTION OF EMBODIMENTS

### First embodiment

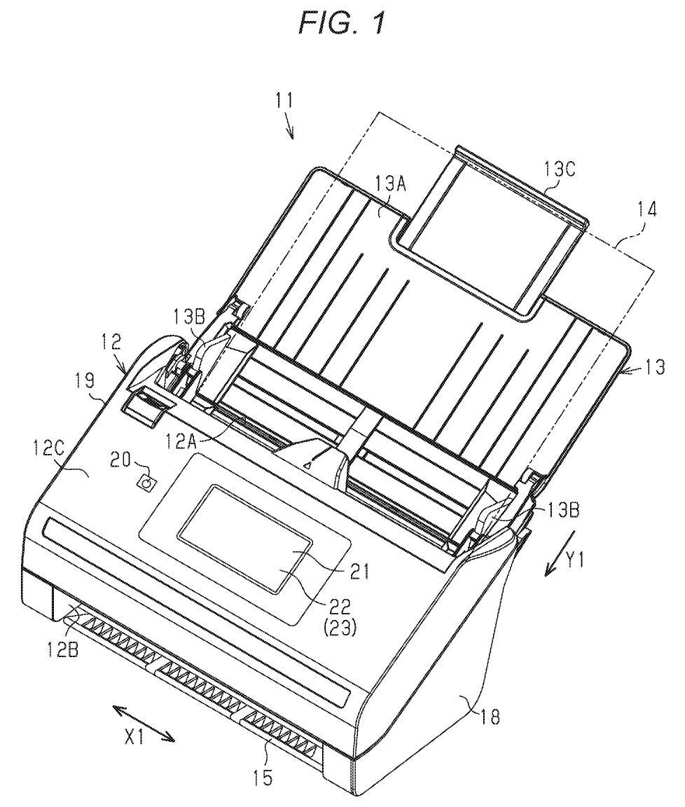

Hereinafter, a first embodiment of an image reading device will be described with reference to the drawings. An image reading device 11, which is an example of a processing device shown in FIG. 1, executes image reading processing of reading an image of a document 14, which is an example of a medium, as processing related to an image on a medium conveyed along a conveyance path.

As shown in FIG. 1, the image reading device 11 includes a main body 12 having a substantially trapezoidal shape in a side view, and a document support 13 which is an example of a medium placement portion on which the document 14, which is an example of a medium, is placed (set). In the main body 12, a stacker 15 is housed below a discharge port 12B in a state where the stacker 15 can slide in a front-rear direction.

The document support 13 has a flat placement surface 13A on which a plurality of the documents 14 can be placed by obliquely extending the documents 14 rearward and upward of the main body 12. The document support 13 is provided with a pair of edge guides 13B that can slide in a width direction X1 intersecting (particularly, orthogonal to) a conveyance direction Y1 in which the document 14 is conveyed. The document 14 stacked on the placement surface 13A is positioned in the width direction X1 with respect to a feeding port 12A in a manner in which the document 14 is sandwiched between the pair of edge guides 13B. A sliding auxiliary support portion 13C is provided at the placement surface 13A of the document support 13 in a retractable manner. The document 14 stacked on the placement surface 13A is positioned in the conveyance direction Y1 with respect to the feeding port 12A when the document 14 comes into contact with the sliding auxiliary support portion 13C. A direction parallel to the width direction X1 is a main scanning direction when the image reading device 11 reads the document 14, and a direction parallel to the conveyance direction Y1 is a sub scanning direction. Hereinafter, the directions are also referred to as a main scanning direction X1 and a sub scanning direction Y1.

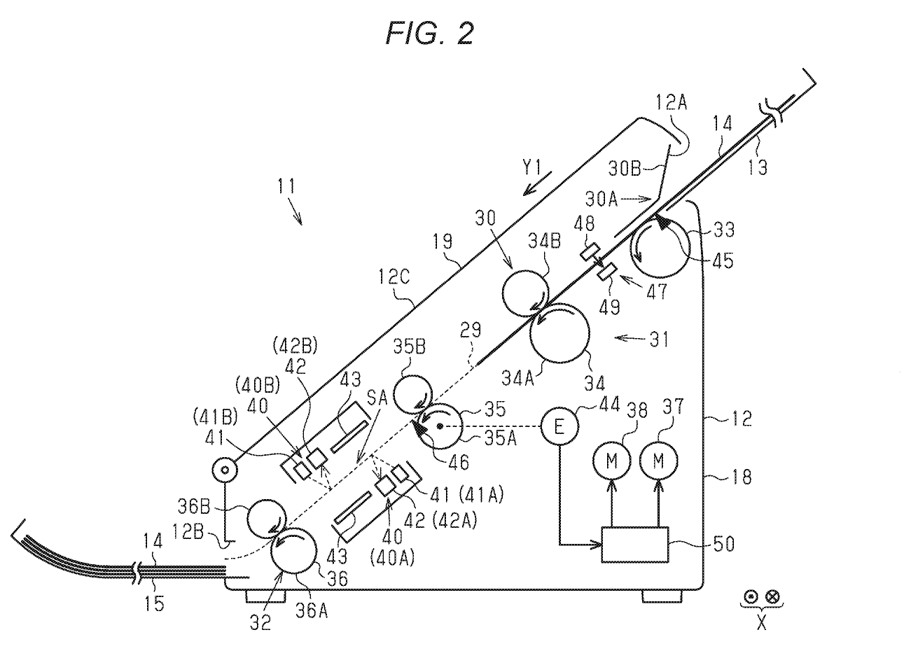

The documents 14 placed on the document support 13 are fed one by one into the main body 12 from the feeding port 12A opened in an upper portion of the main body 12. The fed document 14 is conveyed along a predetermined conveyance path 29 (see FIG. 2) in the main body 12, and after an image is read in a reading region SA during the conveyance, the document 14 is discharged from the discharge port 12B opened in a front lower portion of the main body 12.

A power button 20 is provided on a front surface portion 12C of the main body 12. The front surface portion 12C of the main body 12 is provided with a display unit 22 such as a liquid crystal panel that displays a predetermined image in a display region 23. The display unit 22 displays information such as a menu, a selection item, and an operation status of the image reading device 11. The display unit 22 is provided with an operation unit 21 such as a touch panel capable of detecting a touch operation of a user. The operation unit 21 is configured to input necessary information according to a touch operation of a user when an instruction is given to the image reading device 11.

As shown in FIG. 2, the main body 12 includes a main body portion 18 and a cover portion 19 coupled to the main body portion 18 so as to be rotatable about a front end portion of the main body portion 18. The main body 12 has the conveyance path 29 extending from the feeding port 12A to the discharge port 12B between the main body portion 18 and the cover portion 19.

As shown in FIG. 2, the image reading device 11 includes a conveyance device 30 and an image reading unit 40, which is an example of an image processing unit, in the main body 12. The conveyance device 30 includes a conveyance unit 31, a control unit 50 that controls the conveyance unit 31, and an ultrasonic sensor 47. The conveyance unit 31 conveys the document 14 along the conveyance path 29.

The conveyance device 30 includes a document placement sensor 45 and a medium sensor 46 in addition to the ultrasonic sensor 47 as a detection system that detects the document 14. The medium sensor 46 detects the document 14, which is an example of a medium conveyed along the conveyance path 29, at a position upstream of the image reading unit 40 in the conveyance path 29.

The conveyance unit 31 includes a feeding unit 30A that guides and feeds the documents 14 stacked (set) on the document support 13 one by one into the main body 12. The conveyance unit 31 conveys the fed document 14 so as to pass through a reading region SA along the conveyance path 29. The conveyance unit 31 includes a discharge unit 32 that discharges the document 14 after the image is read during the conveyance. The conveyance device 30 has an automatic document feeding function of sequentially conveying the plurality of documents 14 stacked on the document support 13 one by one along the conveyance path 29 so as to pass through the reading region SA.

The feeding unit 30A includes one feeding roller 33 facing a feeding guide 30B at an upstream end position of the conveyance path 29 in the main body 12. The feeding unit 30A feeds the plurality of documents 14 stacked on the document support 13 one by one from the feeding port 12A along the feeding guide 30B. The feeding unit 30A may include a separation mechanism that separates the documents 14 fed by the feeding roller 33 into separate documents. The separation mechanism may include a movable separation roller (not shown) that moves to a separation position when the feeding roller 33 feeds the documents 14.

The conveyance unit 31 includes a first conveyance roller pair 34 disposed at a position downstream of the feeding roller 33 in the conveyance direction Y1, and a second conveyance roller pair 35 disposed at a position upstream of the reading region SA in the conveyance direction Y1. The first conveyance roller pair 34 includes a drive roller 34A and a driven roller 34B. The second conveyance roller pair 35 includes a drive roller 35A and a driven roller 35B.

The discharge unit 32 includes a discharge roller pair 36 disposed at a position downstream of the reading region SA in the conveyance direction Y1. The discharge roller pair 36 includes a drive roller 36A and a driven roller 36B. The discharge roller pair 36 also conveys the document 14 during reading together with the second conveyance roller pair 35.

As described above, the feeding roller 33, the first conveyance roller pair 34, the second conveyance roller pair 35, and the discharge roller pair 36 are disposed in this order from an upstream side in the conveyance direction Y1, and are disposed in pairs at intervals in the width direction X1.

The plurality of rollers 33 and 34A of a feeding system are rotationally driven by power of a feeding motor 37 which is a power source. The plurality of documents 14 stacked on the document support 13 are sequentially fed by the feeding roller 33 from the feeding port 12A into the main body 12 one by one from a lowermost document. In this manner, the feeding unit 30A (the rollers 33, 34A and the like) is driven by the feeding motor 37 as a power source.

The drive rollers 35A and 36A of a conveyance system are rotationally driven by power of a conveyance motor 38 which is a power source. The document 14 fed into the main body 12 by the feeding roller 33 is conveyed to the reading region SA and then discharged from the discharge port 12B. In this manner, the conveyance unit 31 (the first conveyance roller pair 34 and the like) and the discharge unit 32 (the discharge roller pair 36 and the like) are driven by the conveyance motor 38 as a common power source. The feeding unit 30A may also be driven by the conveyance motor 38, thereby reducing the number of motors.

The drive rollers 35A and 36A are rotationally driven to convey the document 14 at the same conveyance speed (reading speed) when the document 14 is read. The driven rollers 35B and 36B are rotated by the rotation of the drive rollers 35A and 36A of the respective pairs.

An encoder 44 (for example, a rotary encoder) capable of detecting rotation of one drive roller of the conveyance system among the plurality of roller pairs 34 to 36 is provided in the main body 12.

The encoder 44 outputs a detection signal including the number of pulses proportional to a rotation amount of a drive roller to the control unit 50. Therefore, the control unit 50 can acquire a position (conveyance position) and a conveyance speed of the document 14 being conveyed based on the detection signal of the encoder 44.

The document placement sensor 45 is disposed at a position slightly upstream of the feeding roller 33 in the conveyance direction Y1. The document placement sensor 45 detects the presence or absence of the document 14 placed (set) on the document support 13.

The medium sensor 46 is disposed at a position slightly downstream of a nip point of the second conveyance roller pair 35 in the conveyance direction Y1. The medium sensor 46 detects the presence or absence of the document 14.

The medium sensor 46 detects the document 14, which is conveyed along the conveyance path 29, at a position upstream of the image reading unit 40 in the conveyance path 29. The ultrasonic sensor 47 is positioned upstream of the medium sensor 46 in the conveyance path 29.

Based on a detection signal (ON/OFF) of the medium sensor 46, the control unit 50 detects that a leading end of the document 14 passed through the second conveyance roller pair 35 and that a trailing end of the document 14 passed through the second conveyance roller pair 35. The detection result indicating that the medium sensor 46 detects the leading end and the trailing end of the document 14 is used for control for determining a timing of start and end of a reading operation of the image reading unit 40 (40A, 40B) to be described later. The detection result indicating that the medium sensor 46 detecting the trailing end of the document 14 is used for determining a feeding start timing of the subsequent document 14 (subsequent medium) to be fed subsequent to the preceding document 14 (preceding medium). In the control unit 50, a period from when the medium sensor 46 detects that the trailing end of the document 14 passes a detection position of the ultrasonic sensor 47 to when the feeding of the subsequent document 14 to be fed subsequent to the preceding document 14 is started is a gap period in which a gap between the preceding document 14 and the subsequent document 14 is at a detection position of the ultrasonic sensor 47. At least a predetermined period of the gap period may be a non-detection period in which the ultrasonic sensor 47 does not execute multiple feeding detection processing.

The image reading device 11 includes the image reading unit 40 that reads an image of the document 14 in the main body 12. The image reading unit 40 is an example of an image processing unit that executes processing related to an image on a medium conveyed along the conveyance path 29. The image reading unit 40 executes image reading processing of reading an image of the document 14 as processing related to an image on a medium.

The image reading unit 40 is provided as a pair on both sides of the conveyance path 29 at a position between the second conveyance roller pair 35 and the discharge roller pair 36 in the conveyance direction Y1. In the present embodiment, the pair of image reading units 40 includes the first image reading unit 40A that reads a front surface (lower surface) of the document 14 conveyed along the conveyance path 29, and the second image reading unit 40B that reads a back surface (upper surface) of the document 14 conveyed along the conveyance path 29. The pair of image reading units 40 are disposed at positions slightly shifted from each other in the conveyance direction Y1. Alternatively, one image reading unit 40 may not be provided.

Each of the pair of image reading units 40 includes a light source 41 capable of irradiating the document 14 being conveyed with light by irradiating the reading region SA with light, and an image sensor 42 capable of reading an image from the document 14. In a general reading mode, only the first image reading unit 40A performs the reading operation to read the front surface of the document 14, and in a double-side reading mode, both the first image reading unit 40A and the second image reading unit 40B perform a reading operation to read both surfaces (front and back surfaces) of the document 14.

The light source 41 includes, for example, an LED or a fluorescent lamp. The image sensor 42 receives light irradiated from the light source 41 and reflected by the document 14, converts the received light into an electric signal, and outputs a pixel signal having a value corresponding to an amount of received light. As described above, the image sensor 42 is a sensor that reads an image. The image sensor 42 is, for example, a linear image sensor. The image reading device 11 can perform color scanning and monochrome scanning (grayscale scanning). Hereinafter, the light source 41 and the image sensor 42 close to the first image reading unit 40A may be referred to as a first light source 41A and a first image sensor 42A, and the light source 41 and the image sensor 42 close to the second image reading unit 40B may be referred to as a second light source 41B and a second image sensor 42B.

The image sensor 42 is, for example, a contact-type image sensor in which a plurality of photoelectric conversion elements are arranged in a line along the main scanning direction X1. Further, the image sensor 42 is specifically a complementary metal oxide semiconductor (CMOS) image sensor. The image sensor 42 photoelectrically converts light received by each photoelectric conversion element and outputs a pixel signal having a value corresponding to an amount of received light.

For example, in the case of double-side reading, both sides of the document 14 are read by the first image sensor 42A and the second image sensor 42B. In the case of single-side reading, a front surface of the document 14 is read by the first image sensor 42A. The image sensors 42A and 42B set a region wider than the maximum document size readable by the image reading device 11 as a reading region.

Further, a background plate 43 is disposed at a position facing the image sensor 42 across the conveyance path 29. The background plate 43 is disposed over a region wider than a conveyance region of the document 14 in the main scanning direction X1 in a reading target range of the image reading unit 40. The image sensors 42A and 42B read the background plate 43 in a region where the document 14 is not present. Therefore, the background plate 43 is read as the background of the document 14.

### Configuration of Ultrasonic Sensor 47

The ultrasonic sensor 47 shown in FIG. 2 detects multiple feeding of the document 14 conveyed along the conveyance path 29. In the present embodiment, the ultrasonic sensor 47 is disposed between the feeding roller 33 and the first conveyance roller pair 34. In other words, the ultrasonic sensor 47 is located upstream of the first conveyance roller pair 34 in the conveyance path 29. The ultrasonic sensor 47 is located downstream of the feeding roller 33 in the conveyance path 29. The ultrasonic sensor 47 is positioned upstream of the medium sensor 46 in the conveyance path 29.

The ultrasonic sensor 47 is disposed along the conveyance path 29. The ultrasonic sensor 47 is a part of the configuration of the conveyance device 30. The ultrasonic sensor 47 includes a transmission unit 48 and a reception unit 49. The transmission unit 48 and the reception unit 49 are disposed at positions facing each other across the conveyance path 29.

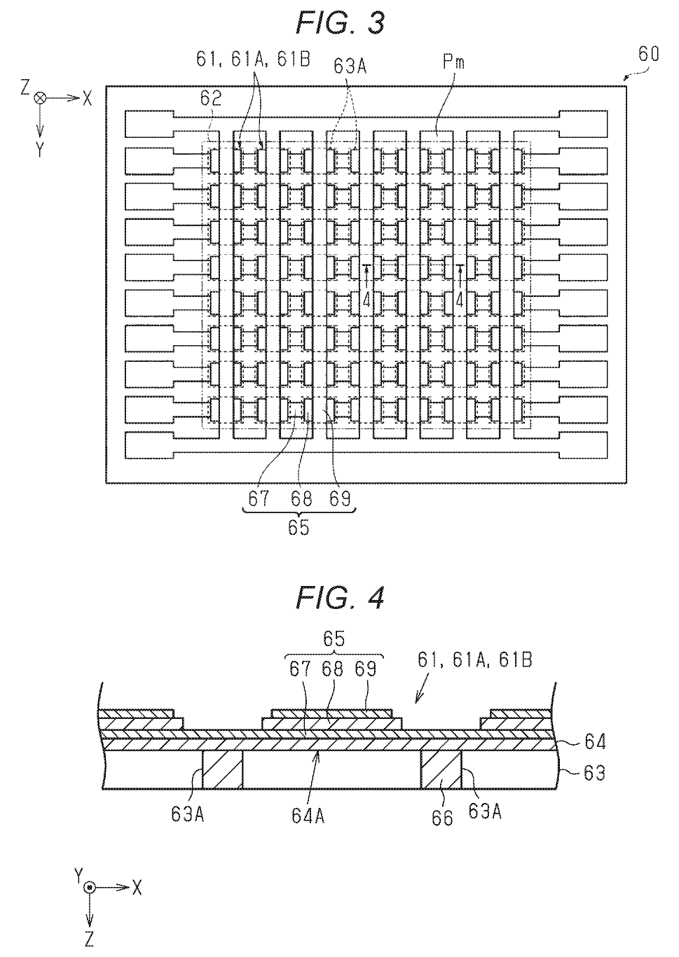

The transmission unit 48 transmits ultrasonic waves. The transmission unit 48 includes an ultrasonic transmission element 61A (see FIG. 3). The ultrasonic transmission element 61A transmits ultrasonic waves. The ultrasonic waves transmitted by the ultrasonic transmission element 61A are transmitted from the transmission unit 48 toward the conveyance path 29. When the ultrasonic waves are transmitted while the document 14 is conveyed to a position facing the transmission unit 48, the ultrasonic waves pass through the document 14 and are transmitted to the reception unit 49. When the ultrasonic waves pass through the document 14, sound pressure of the ultrasonic waves is attenuated.

The reception unit 49 receives the ultrasonic waves. The reception unit 49 includes an ultrasonic reception element 61B (see FIG. 3). The ultrasonic reception element 61B receives ultrasonic waves. The ultrasonic waves transmitted from the transmission unit 48 toward the conveyance path 29 are received by the ultrasonic reception element 61B of the reception unit 49. The reception unit 49 receives the ultrasonic waves that are transmitted from the transmission unit 48 and that passed through the conveyance path 29. When the ultrasonic waves are transmitted while the document 14 is conveyed to a position facing the transmission unit 48, the reception unit 49 receives the ultrasonic waves that passed through the document 14. The reception unit 49 generates a reception signal corresponding to sound pressure of the ultrasonic waves. The reception unit 49 transmits the generated reception signal to the control unit 50.

The ultrasonic sensor 47 includes the ultrasonic transmission element 61A and the ultrasonic reception element 61B. That is, the transmission unit 48 includes the ultrasonic transmission element 61A. The reception unit 49 includes the ultrasonic reception element 61B. The ultrasonic transmission element 61A and the ultrasonic reception element 61B are disposed at positions facing each other across the conveyance path 29.

The transmission unit 48 and the reception unit 49 have the same configuration. Configurations of the transmission unit 48 and the reception unit 49 will be described later. The ultrasonic sensor 47 includes the transmission unit 48 and the reception unit 49, but is not limited to this configuration. The transmission unit 48 may have a function of the reception unit 49. The transmission unit 48 receives ultrasonic waves reflected from the document 14. The transmission unit 48 generates a reception signal corresponding to sound pressure of the received ultrasonic waves. The transmission unit 48 transmits the generated reception signal to the control unit 50.

The control unit 50 receives the reception signal output by the ultrasonic sensor 47. The control unit 50 detects multiple feeding of the document 14 based on the received reception signal. When multiple feeding is detected, the control unit 50 stops the conveyance of the document 14. The control unit 50 controls the conveyance device 30 to stop the conveyance of the document 14. The control unit 50 controls driving of the ultrasonic sensor 47. The control unit 50 controls driving of the ultrasonic transmission element 61A (see FIG. 3) of the transmission unit 48. The control unit 50 controls driving of the ultrasonic reception element 61B (see FIG. 3) of the reception unit 49. The ultrasonic sensor 47 and the control unit 50 are examples of an ultrasonic device.

Each of the transmission unit 48 and the reception unit 49 includes an ultrasonic element substrate 60 shown in FIG. 3.

### Configuration of Ultrasonic Element Substrate 60

Next, a configuration of the ultrasonic element substrate 60 will be described with reference to FIG. 3. The ultrasonic element substrate 60 includes a plurality of ultrasonic elements 61. The ultrasonic element 61 transmits an ultrasonic wave or receives an ultrasonic wave according to a supplied drive signal. In the ultrasonic element substrate 60 of the transmission unit 48, the ultrasonic element 61 is referred to as the ultrasonic transmission element 61A. In the ultrasonic element substrate 60 of the reception unit 49, the ultrasonic element 61 is referred to as the ultrasonic reception element 61B. The plurality of ultrasonic elements 61 are formed at a main surface Pm of the ultrasonic element substrate 60. The main surface Pm is one of two surfaces having a largest area among a plurality of surfaces constituting the ultrasonic element substrate 60.

An X axis, a Y axis, and a Z axis are shown in a plurality of drawings including FIG. 3. The Z axis is along a direction perpendicular to the main surface Pm. The X axis is an axis orthogonal to the Z axis. The X axis is an axis parallel to a long side of the ultrasonic element substrate 60. The Y axis is an axis orthogonal to both the Z axis and the X axis. The Y axis is an axis parallel to a short side of the ultrasonic element substrate 60. Arrows are added to the X axis, the Y axis, and the Z axis. A direction indicated by the arrow is a + direction. A direction opposite to the + direction is defined as a - direction. The +Z direction is a direction from the main surface Pm toward a back surface of the main surface Pm. FIG. 3 is a plan view showing the ultrasonic element substrate 60 in the +Z direction.

In the ultrasonic element substrate 60, the plurality of ultrasonic elements 61 constitute an element array 62. The element array 62 is an array of the plurality of ultrasonic elements 61. In the ultrasonic element substrate 60, the plurality of ultrasonic elements 61 form a matrix in which an array along the X axis is set as a row and an array along the Y axis is set as a column. As shown in FIG. 4 which is a cross-sectional view taken along a line 4-4 in FIG. 3, the ultrasonic element substrate 60 includes a substrate main body portion 63, a vibration plate 64, and a piezoelectric element 65. The substrate main body portion 63, the vibration plate 64, and the piezoelectric element 65 are disposed along the Z axis. The vibration plate 64 is disposed in the -Z direction of the substrate main body portion 63. The piezoelectric element 65 is disposed in the -Z direction of the vibration plate 64.

The substrate main body portion 63 is formed of a semiconductor substrate such as Si. A plurality of opening portions 63A are formed in the substrate main body portion 63. The opening portion 63A is surrounded by a partition wall 66. The plurality of opening portions 63A are provided along the X axis and the Y axis. The opening portion 63A passes through the substrate main body portion 63. The plurality of opening portions 63A are partitioned by the partition wall 66. Since the vibration plate 64 is provided in the -Z direction of the substrate main body portion 63, one end of the opening portion 63A in the -Z direction is closed by the vibration plate 64. The opening portion 63A opens in the +Z direction. In the ultrasonic element substrate 60, the vibration plate 64 is exposed through the opening portion 63A. The vibration plate 64 is formed of a stacked body of silicon oxide and zirconium oxide. The vibration plate 64 is supported by the partition wall 66 of the substrate main body portion 63. A vibration surface 64A which is a surface of the vibration plate 64 in the +Z direction is formed.

One opening portion 63A corresponds to one piezoelectric element 65. The opening portion 63A is formed for each piezoelectric element 65. The partition wall 66 is formed by forming the opening portion 63A in the substrate main body portion 63. In other words, a remaining portion of the substrate main body portion 63 where the opening portion 63A is formed serves as the partition wall 66. A portion of the vibration plate 64 overlapping one opening portion 63A and the piezoelectric element 65 overlapping one opening portion 63A constitute one ultrasonic element 61. In the transmission unit 48, one ultrasonic element 61 is one ultrasonic transmission element 61A. In the transmission unit 48, the vibration plate 64 vibrates to transmit ultrasonic waves from the vibration surface 64A. The ultrasonic transmission element 61A converts an electric signal into an ultrasonic wave. The ultrasonic reception element 61B converts the ultrasonic wave into an electric signal. In the transmission unit 48, the ultrasonic transmission element 61A converts the electric signal into an ultrasonic wave and transmits the ultrasonic wave. In the reception unit 49, the ultrasonic reception element 61B receives the ultrasonic wave and converts the ultrasonic wave into an electric signal.

In the reception unit 49, one ultrasonic element 61 is one ultrasonic reception element 61B.

The ultrasonic reception element 61B includes a piezoelectric element 65 stacked on the vibration plate 64. In the reception unit 49, the vibration plate 64 vibrates when the vibration surface 64A receives the ultrasonic wave. An electric signal is output from the piezoelectric element 65 corresponding to the vibration of the vibration plate 64. When the vibration plate 64 receives an ultrasonic wave and vibrates, the piezoelectric element 65 converts the vibration into a signal. The plurality of piezoelectric elements 65 are provided on a surface of the vibration plate 64 in the -Z direction. The piezoelectric element 65 is disposed at a position in the -Z direction of the opening portion 63A. The piezoelectric element 65 includes a first electrode 67, a piezoelectric body 68, and a second electrode 69. The second electrode 69 faces the first electrode 67. The piezoelectric body 68 is interposed between the first electrode 67 and the second electrode 69.

The first electrode 67 is disposed on a surface of the vibration plate 64 in the -Z direction. The first electrode 67, the piezoelectric body 68, and the second electrode 69 are stacked in this order on the surface of the vibration plate 64 in the -Z direction. The piezoelectric body 68 is made of a piezoelectric material such as lead zirconate titanate (PZT).

As shown in FIG. 3, the first electrode 67 is an electrode commonly coupled to the plurality of piezoelectric elements 65 for each row of the element array 62. The second electrode 69 is an electrode commonly coupled to the plurality of piezoelectric elements 65. In the ultrasonic transmission element 61A, the first electrode 67 transmits an electric signal to the piezoelectric bodies 68 of the plurality of piezoelectric elements 65. The piezoelectric body 68 expands and contracts according to an electric signal. When a pulse wave voltage of a predetermined frequency is applied between the first electrode 67 and the second electrode 69, the piezoelectric body 68 expands and contracts. Due to the expansion and contraction of the piezoelectric body 68, the vibration surface 64A shown in FIG. 4 vibrates at a frequency corresponding to an opening width of the opening portion 63A or the like. Accordingly, the ultrasonic transmission element 61A transmits an ultrasonic wave.

In the ultrasonic reception element 61B, the first electrode 67 receives electric signals from the piezoelectric bodies 68 of the plurality of piezoelectric elements 65. In the ultrasonic reception element 61B, when the vibration surface 64A shown in FIG. 4 receives ultrasonic waves, the piezoelectric body 68 expands and contracts via the vibration plate 64. When the piezoelectric body 68 expands and contracts, a potential difference between the first electrode 67 and the second electrode 69 changes. The ultrasonic reception element 61B outputs an electric signal corresponding to a change in the potential difference. The generated electric signal is output to the control unit 50 as a reception signal.

### Electric Configuration of Image Reading Device 11

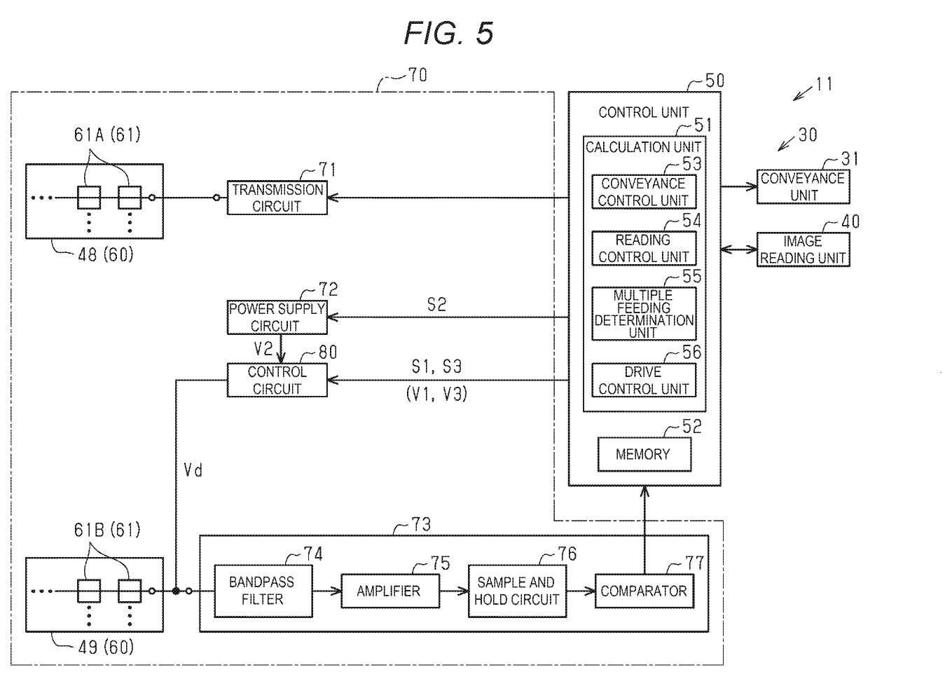

Next, an electrical configuration of the image reading device 11 will be described with reference to FIG. 5. As shown in FIG. 5, the image reading device 11 includes the control unit 50 and an ultrasonic detection device 70. The ultrasonic detection device 70 includes the ultrasonic transmission element 61A that transmits ultrasonic waves, the piezoelectric ultrasonic reception element 61B that receives ultrasonic waves, and a control circuit 80. The control unit 50 controls the control circuit 80. The ultrasonic detection device 70 further includes a transmission circuit 71, a power supply circuit 72 which is an example of a power supply, and a reception circuit 73. The ultrasonic detection device 70 includes the transmission unit 48 including the ultrasonic transmission element 61A and the reception unit 49 including the ultrasonic reception element 61B. The present embodiment is characterized by the control circuit 80 that applies a DC voltage Vd to the piezoelectric ultrasonic reception element 61B. The control circuit 80 generates the DC voltage Vd to be applied to the ultrasonic reception element 61B. The DC voltage Vd includes a reception drive voltage J1 and a high voltage J2. The image reading device 11 may include an interface unit for communicating with an external device such as a personal computer.

The control unit 50 includes a computer (not shown) including a microprocessor or the like.

The computer may include a memory 52 (storage unit) including a RAM, a nonvolatile memory, and the like. The memory 52 stores a program. The control unit 50 is not limited to the one that executes software processing for all processing executed by the control unit 50. For example, the control unit 50 may include a dedicated hardware circuit (for example, an application specific integrated circuit: ASIC) that executes hardware processing for at least part of processing executed by the control unit 50. That is, the control unit 50 may be configured as a circuitry including one or more processors that operate according to a computer program (software), one or more dedicated hardware circuits that execute at least part of various types of processing, or a combination thereof. The processor includes a CPU and the memory 52 such as a RAM and a ROM, and the memory 52 stores a program code or a command configured to cause the CPU to execute processing. The memory 52, that is, a computer-readable medium includes any available medium that can be accessed by a general-purpose or dedicated computer.

The control unit 50 includes a calculation unit 51 and the memory 52. The calculation unit 51 includes a conveyance control unit 53, a reading control unit 54, a multiple feeding determination unit 55, and a drive control unit 56. The memory 52 functions as a work area of the control unit 50. The control unit 50 functions as various functional units by executing control programs stored in the memory 52.

The control unit 50 executes control programs stored in the memory 52 to function as functional units of the conveyance control unit 53, the reading control unit 54, the multiple feeding determination unit 55, and the drive control unit 56. The conveyance control unit 53 controls driving of the motors 37 and 38. The conveyance control unit 53 controls the conveyance device 30 by controlling driving of the motors 37 and 38. The reading control unit 54 controls the image reading unit 40. The reading control unit 54 causes the image reading unit 40 to read an image of the document 14.

The transmission circuit 71 is electrically coupled to the ultrasonic transmission element 61A of the transmission unit 48. The transmission circuit 71 generates a drive signal to be applied to each ultrasonic transmission element 61A based on a command from the control unit 50.

The power supply circuit 72 is electrically coupled to the ultrasonic reception element 61B of the reception unit 49. The power supply circuit 72 generates a DC voltage to be applied to each ultrasonic reception element 61B based on a command from the control unit 50. The transmission circuit 71 and the power supply circuit 72 are each controlled by the drive control unit 56 of the control unit 50. The reception circuit 73 executes various kinds of processing on a reception signal output from the ultrasonic reception element 61B of the reception unit 49, and then outputs the reception signal to the control unit 50.

The power supply circuit 72 inputs, for example, a power supply voltage VE (for example, 24 V) which is a DC voltage obtained by converting a commercial AC voltage by a power supply adapter (not shown) coupled to a power supply port of the image reading device 11. The power supply circuit 72 includes a DC/DC converter (not shown) that converts the power supply voltage VE into a predetermined voltage (for example, 3.3 V) lower than the power supply voltage VE. The power supply circuit 72 outputs the power supply voltage VE and the predetermined voltage (for example, 3.3 V). The predetermined voltage (for example, 3.3 V) is supplied to the control unit 50.

The power supply circuit 72 includes a switching circuit (not shown) controlled by the control unit 50. The control unit 50 turns on and turns off the switching circuit according to a control signal S2 output to the power supply circuit 72. A supply voltage V2 supplied from the power supply circuit 72 to the control circuit 80 is switched between a ground voltage Vgrd (for example, 0 V) and the power supply voltage VE when the control unit 50 turns on and turns off the switching circuit in the power supply circuit 72. For example, when the image reading device 11 is powered on, the control unit 50 switches the supply voltage V2, which is supplied from the power supply circuit 72 to the control circuit 80, from the ground voltage Vgrd (for example, 0 V) to the power supply voltage VE. When the image reading device 11 is powered on, the power supply voltage VE is supplied to the control circuit 80.

In the power-on state, the supply of the power supply voltage VE to the control circuit 80 may be stopped in a sleep mode. That is, in the sleep mode, the control unit 50 switches the control signal S2 from ON to OFF to stop the supply of the power supply voltage VE to the control circuit 80. Thereafter, when the sleep mode ends, the control unit 50 switches the control signal S2 from OFF to ON to resume the supply of the power supply voltage VE to the control circuit 80.

The control unit 50 may supply the power supply voltage VE to the control circuit 80 only when voltage supply to the ultrasonic reception element 61B constituting the ultrasonic sensor 47 is required.

The control circuit 80 receives control signals S1 and S3 from the control unit 50 (specifically, the drive control unit 56). The control circuit 80 generates a DC voltage to be applied to the ultrasonic reception element 61B from the power supply voltage VE based on the control signals S1 and S3. The control circuit 80 controls the power supply voltage VE supplied from the power supply circuit 72 to switch the DC voltage Vd applied to the ultrasonic reception element 61B. One feature of the control circuit 80 is that the control circuit 80 can generate a second DC voltage J2 (high voltage J2), which is a DC voltage higher than the power supply voltage VE, from the power supply voltage VE and apply the second DC voltage J2 to the ultrasonic reception element 61B. A detailed configuration of the control circuit 80 will be described later.

The reception circuit 73 includes a bandpass filter 74, an amplifier 75, a sample and hold circuit 76, and a comparator 77. A reception signal output from the reception unit 49 is input to the bandpass filter 74. The bandpass filter 74 removes a noise component and the like from the reception signal. The reception signal is amplified by the amplifier 75 to have a predetermined signal intensity or more. Next, the reception signal is input to the sample and hold circuit 76. The sample and hold circuit 76 samples the reception signal at a predetermined frequency. The sampled reception signal is input to the comparator 77. The comparator 77 detects a reception signal whose signal intensity exceeds a predetermined determination intensity among the sampled reception signals. The comparator 77 transmits the reception signal whose signal intensity exceeds the determination intensity to the control unit 50.

The multiple feeding determination unit 55 detects a multiple feeding state of the documents 14. The reception unit 49 receives ultrasonic waves transmitted from the transmission unit 48 and transmitted through the document 14. The reception unit 49 outputs a reception signal corresponding to the received ultrasonic waves. The multiple feeding determination unit 55 determines a state of the document 14 based on the reception signal input from the reception unit 49. When a voltage value of the reception signal is smaller than a determination value, the multiple feeding determination unit 55 determines that the documents 14 are multiple fed. When the multiple feeding determination unit 55 determines that the documents 14 are multiple fed, the conveyance control unit 53 stops the conveyance of the document 14.

The drive control unit 56 instructs the transmission circuit 71 to generate a drive signal. After receiving the generation instruction of the drive signal, the transmission circuit 71 outputs a pulse wave voltage of a predetermined frequency to the transmission unit 48 as the drive signal. In the present embodiment, the drive signal output to the transmission unit 48 is a burst wave drive signal. Driving the ultrasonic transmission element 61A according to a drive signal output from the transmission circuit 71 to the transmission unit 48 is referred to as transmission drive.

The drive control unit 56 controls the power supply circuit 72. The drive control unit 56 controls the power supply circuit 72 to control a drive voltage applied to the ultrasonic reception element 61B. The drive control unit 56 controls the power supply circuit 72 to apply a DC voltage to the ultrasonic reception element 61B or stops the application of the DC voltage. The drive control unit 56 controls the power supply circuit 72 to change a voltage value of the drive voltage applied to the ultrasonic reception element 61B. Applying the drive voltage to the ultrasonic reception element 61B by the drive control unit 56 controlling the power supply circuit 72 is referred to as reception drive.

The transmission unit 48, the reception unit 49, the transmission circuit 71, the power supply circuit 72, the reception circuit 73, and the drive control unit 56 are parts of a configuration of the ultrasonic detection device 70. The drive control unit 56 serving as a functional unit is an example of a control unit. The ultrasonic detection device 70 includes the transmission unit 48, the reception unit 49, the transmission circuit 71, the power supply circuit 72, the reception circuit 73, and the drive control unit 56. However, components of the ultrasonic detection device 70 are not limited thereto, and may include other configurations.

### Transmission Drive and Reception Drive

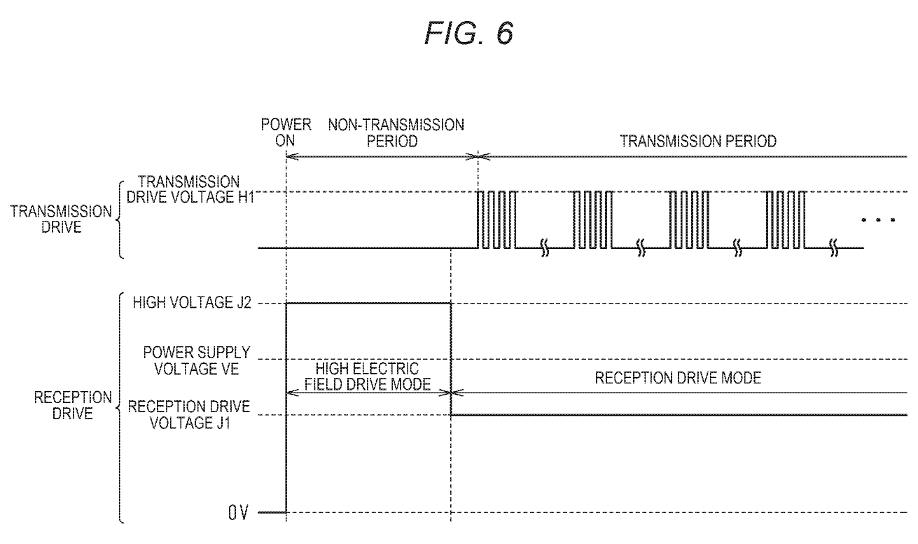

Next, the transmission drive and the reception drive will be described with reference to FIG. 6.

As shown in FIG. 6, after the power supply of the image reading device 11 is changed from off to on, a transmission period starts after a non-transmission period. When the transmission period starts after the non-transmission period, a burst wave drive signal is output from the transmission circuit 71 shown in FIG. 5 to the transmission unit 48. A voltage value of the burst wave drive signal is referred to as a transmission drive voltage H1. In the transmission drive, the non-transmission period and the transmission period alternately occur. A length of the non-transmission period varies depending on an operation of the image reading device 11. A length of the transmission period varies depending on an operation of the image reading device 11.

In the transmission drive, the non-transmission period and the transmission period may each occur once during a period from when the power supply of the image reading device 11 is changed from off to on to when the power supply is turned off. In the transmission drive, the non-transmission period and the transmission period may be alternately repeated during a period from when the power supply of the image reading device 11 is changed from off to on to when the power supply is turned off. In this case, the number of non-transmission periods and the number of transmission periods are not necessarily the same.

As shown in FIG. 6, the reception drive starts at a timing slightly before the start of the transmission period. When the reception drive starts, the reception drive voltage J1 is applied to the reception unit 49. The reception drive voltage J1 is an example of a first DC voltage. Therefore, hereinafter, the reception drive voltage J1 is also referred to as a first DC voltage J1. The reception drive voltage J1 is a voltage value of a reception drive voltage. A mode in which the reception drive voltage J1 is applied to the reception unit 49 is referred to as a reception drive mode. The reception drive mode is a mode in which the ultrasonic reception element 61B can receive ultrasonic waves. The reception unit 49 receives ultrasonic waves in the reception drive mode. When the power supply of the image reading device 11 is turned on, the reception drive mode at the reception drive voltage J1 is maintained. The reception drive mode at the reception drive voltage J1 is maintained until the power supply of the image reading device 11 changes from on to off.

As shown in FIG. 6, when the power supply of the image reading device 11 changes from off to on, a high electric field drive mode is performed before the reception drive mode. The high electric field drive mode is a mode in which a high voltage J2, which is a DC voltage higher than the reception drive voltage J1, is applied to the reception unit 49. The high voltage J2 is an example of a second DC voltage. Therefore, the high voltage J2 is also referred to as a second DC voltage J2. The high electric field drive mode is performed in the non-transmission period of the transmission drive. The high electric field drive mode is performed in the non-transmission period, and the high electric field drive mode is shifted to the reception drive mode before the start of the transmission period.

When the ultrasonic reception element 61B receives ultrasonic waves, the piezoelectric element 65 is driven in the reception drive mode. In the reception drive mode, the first DC voltage J1, which is obtained by applying an electric field having a first electric field intensity to the piezoelectric body 68, is applied between the first electrode 67 and the second electrode 69.

The piezoelectric element 65 is driven in the high electric field drive mode before the execution of the reception drive mode. The second DC voltage J2, which is obtained by applying an electric field having a second electric field intensity higher than the first electric field intensity to the piezoelectric body 68, is applied between the first electrode 67 and the second electrode 69.

An electric field intensity applied to one ultrasonic reception element 61B when the DC voltage of the reception drive voltage J1 is applied to the reception unit 49 is about 5 kV/mm. The electric field intensity is an example of a first electric field intensity applied to one ultrasonic reception element 61B in the reception drive mode. Meanwhile, the electric field intensity applied to one ultrasonic reception element 61B when the DC voltage of the high voltage J2 is applied to the reception unit 49 is a predetermined value within a range of 8 kV/mm to 15 kV/mm. The electric field intensity is an example of a second electric field intensity applied to one ultrasonic reception element 61B in the high electric field drive mode. In the present embodiment, the second electric field intensity is larger than 1.5 times the first electric field intensity. Specific numerical values of the first electric field intensity and the second electric field intensity are examples, and performing the high electric field drive mode before the reception drive mode regardless of values of the electric field intensity applied to one ultrasonic reception element 61B is effective in reducing the sensitivity decrease of the reception unit 49.

### Configuration and Operation of Control Circuit 80

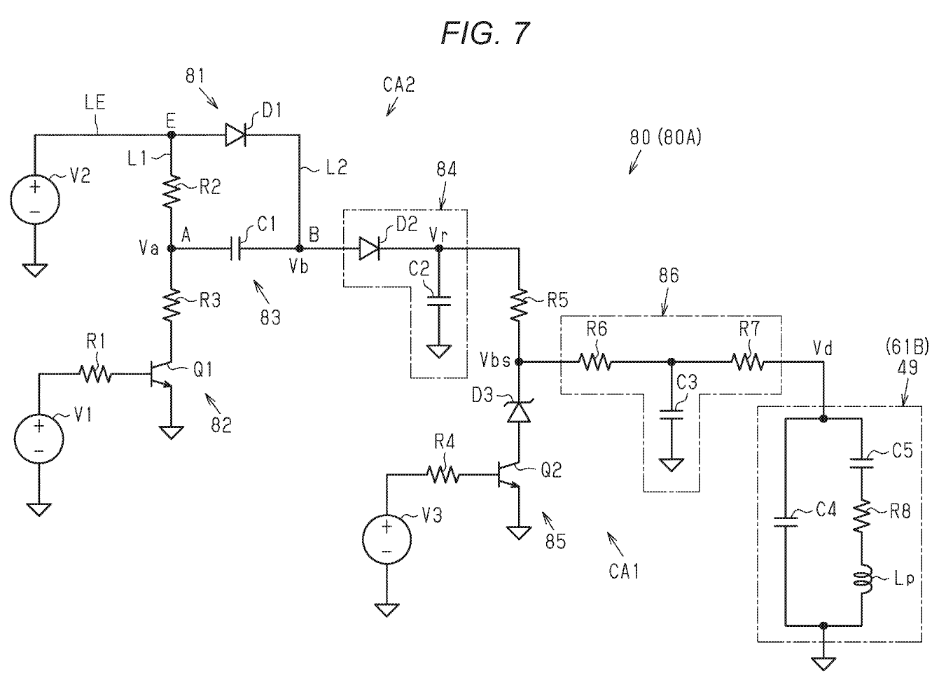

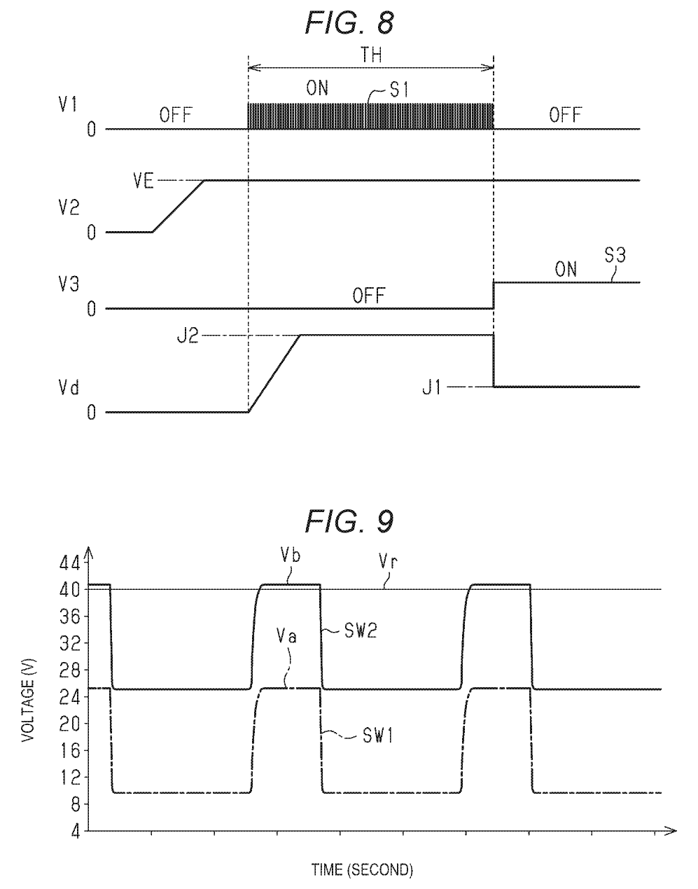

Next, a configuration of the control circuit 80 and an operation of the control circuit 80 that generates the DC voltages J1 and J2 will be described with reference to FIGS. 7 and 8. The control circuit 80 according to the first embodiment is also referred to as a "first control circuit 80A" in order to be distinguished from the control circuit 80 according to a second embodiment to be described later.

The control circuit 80 shown in FIG. 7 receives a supply voltage V2 from the power supply circuit 72. The control circuit 80 receives a voltage V1 of the control signal S1 and a voltage V3 of the control signal S3 from the control unit 50.

The control circuit 80 includes a first voltage generation circuit CA1 that generates the first DC voltage J1 equal to or lower than the power supply voltage VE, and a second voltage generation circuit CA2 that generates the second DC voltage J2 higher than the power supply voltage VE. The control circuit 80 includes a changeover switch Q2 that switches one of the first voltage generation circuit CA1 and the second voltage generation circuit CA2 as an effective circuit configured to generate the DC voltage Vd. The changeover switch Q2 is, for example, a transistor.

The control circuit 80 generates the DC voltage Vd to be applied to the reception unit 49. In the first embodiment, the control circuit 80 generates the reception drive voltage J1 (first DC voltage J1) applied to the reception unit 49 in the reception drive mode and the high voltage J2 (second DC voltage J2) applied to the reception unit 49 in the high electric field drive mode. The control circuit 80 applies the DC voltage Vd to the ultrasonic reception element 61B constituting the reception unit 49. The DC voltage Vd is a bias voltage applied to the ultrasonic reception element 61B. In FIG. 7, the reception unit 49 is shown as an equivalent circuit of the ultrasonic reception element 61B which is a component of the reception unit 49.

### Control Signals S1 and S3 for Controlling Control Circuit 80

First, the control signals S1 and S3 for controlling the control circuit 80 will be described with reference to FIG. 8. FIG. 8 is a timing chart showing control contents of the control circuit 80. FIG. 8 shows the voltage V1 of the control signal S1, the supply voltage V2, the voltage V3 of the control signal S3, and the application voltage Vd in order from the top. Each vertical axis represents a voltage value, and each horizontal axis represents time.

The supply voltage V2 is controlled based on the control signal S2 output from the control unit 50 to the power supply circuit 72. The control signal S2 is an ON and OFF signal. The supply voltage V2 is 0 V when the control signal S2 is turned off. When the power supply of the image reading device 11 is turned on, the control signal S2 is switched from OFF to ON, so that the supply voltage V2 rises from 0 V to the power supply voltage VE. The power supply voltage VE is a standard output voltage of 24 V supplied from a power supply adapter (not shown). However, the power supply voltage VE actually supplied from the power supply adapter is a slightly higher voltage that guarantees the standard output voltage. The power supply voltage VE is, for example, about 25 V. The power supply voltage VE may have another voltage value. The power supply voltage VE in the present embodiment is used, for example, as a drive voltage of the motors 37 and 38 or the image reading unit 40.

The control signal S1 is a signal input from the control unit 50 by the control circuit 80. The control signal S1 is an ON and OFF signal whose voltage V1 becomes 0 V (Vgrd = 0) when the control signal S1 is turned off and which is used to output a rectangular wave of a predetermined frequency f1 when the control signal S1 is turned on. Specifically, the rectangular wave has a minimum potential of 0 V and a maximum potential of 3.3 V, and the predetermined frequency f1 is, for example, 100 kHz. The duty of the rectangular wave is, for example, 50%. The control signal S1 is turned off in the reception drive mode, and is used to output the rectangular wave having the predetermined frequency f1 over a time TH in which the high electric field drive mode is performed.

The control signal S3 is an ON and OFF signal input from the drive control unit 56 of the control unit 50 by the control circuit 80. The voltage V3 of the control signal S3 becomes 0 V (Vgrd = 0) when the control signal S3 is turned off and becomes a predetermined voltage (for example, 3.3 V) when the control signal S3 is turned on. The control signal S3 is a switching signal for switching one of the first voltage generation circuit CA1 and the second voltage generation circuit CA2 to be effective. The control signal S3 is turned off in the high electric field drive mode and is turned on in the reception drive mode.

The DC voltage Vd is a DC voltage generated by the control circuit 80. The DC voltage Vd is applied to the ultrasonic reception element 61B constituting the ultrasonic sensor 47. When the power supply voltage VE is supplied to the control circuit 80, the control unit 50 controls the control circuit 80 based on the control signals S1 and S3 to switch between the first DC voltage J1 equal to or lower than the power supply voltage VE and the second DC voltage J2 (Vd = about 40 V) higher than the power supply voltage VE. In the high electric field drive mode in which the control signal S1 is turned on and the control signal S3 is turned off, the control circuit 80 outputs the second DC voltage J2 (high voltage J2) as the DC voltage Vd. Thereafter, in the reception drive mode in which the control signal S1 is turned off and the control signal S3 is turned on, the control circuit 80 outputs the first DC voltage J1 (reception drive voltage J1). A timing of turning off the control signal S1 may be earlier than a timing of turning on the control signal S3.

### Configuration of Second Voltage Generation Circuit CA2

Next, a configuration of the second voltage generation circuit CA2 will be described with reference to FIG. 7. The second voltage generation circuit CA2 includes a booster circuit 81. The second voltage generation circuit CA2 may include a low-pass filter circuit 86. The booster circuit 81 includes a rectangular wave generation circuit 82, a shift-up circuit 83, and a rectifier circuit 84.

The first voltage generation circuit CA1 includes a constant voltage circuit 85 and the low-pass filter circuit 86. The first voltage generation circuit CA1 and the second voltage generation circuit CA2 may share the low-pass filter circuit 86.

The ultrasonic reception element 61B constituting the reception unit 49 includes, in an equivalent circuit, a capacitor C4, a capacitor C5, a resistor R8, and a coil Lp, which are coupled in parallel to the capacitor C4.

The capacitor C5, the resistor R8, and the coil Lp are coupled in series.

The booster circuit 81 boosts the power supply voltage VE to the second DC voltage J2. The booster circuit 81 includes a capacitor C1. When the second voltage generation circuit CA2 is switched to be effective, the booster circuit 81 accumulates charges for boosting in the capacitor C1. The booster circuit 81 boosts the power supply voltage VE to the second DC voltage J2 using a potential difference ΔVc between both sides of the capacitor C1.

The booster circuit 81 applies a positive first potential (for example, a resistor divided voltage) lower than the power supply voltage VE to an input point A which is one of coupling points on both sides of the capacitor C1. A second potential (for example, the power supply voltage VE) higher than the first potential and equal to or lower than the power supply voltage is applied to an output point B which is the other coupling point of both sides of the capacitor C1. Accordingly, the capacitor C1 is charged. After the capacitor C1 is charged, the first potential of the input point A is switched to a third potential (for example, the power supply voltage VE) higher than the first potential and equal to or lower than the power supply voltage VE. Accordingly, the second potential of the output point B is boosted to a fourth potential (> VE) obtained by adding the potential difference ΔVc between both sides of the capacitor C1 after the capacitor C1 is charged to the second potential. By this boosting, the second DC voltage J2 (> VE) is generated.

The booster circuit 81 includes the rectangular wave generation circuit 82, the shift-up circuit 83, and the rectifier circuit 84. The control circuit 80 includes a power supply line LE to which the power supply voltage VE is supplied, a first line L1 coupled to the power supply line LE, and a second line L2 coupled to the power supply line LE.

The rectangular wave generation circuit 82 generates a first rectangular wave having an amplitude equal to or lower than the power supply voltage VE. The rectangular wave generation circuit 82 includes a plurality of (for example, two) resistors R2 and R3 that divide the power supply voltage VE at the input point A. The plurality of resistors R2 and R3 and the input point A are located on the first line L1. That is, the two resistors R2 and R3 are coupled in series on the first line L1, and the input point A is located between the two resistors R2 and R3.

The rectangular wave generation circuit 82 includes a switching element Q1 coupled to the first line L1. The switching element Q1 is turned on and off at the predetermined frequency f1 to generate the first rectangular wave. The switching element Q1 is, for example, a transistor. The voltage V1 of the control signal S1 is input to a base terminal of the switching element Q1 via the resistor R1. The switching element Q1 is turned off when the control signal S1 is turned off. The switching element Q1 repeats ON and OFF at the predetermined frequency f1 when the control signal S1 is turned on. Accordingly, the first rectangular wave having the predetermined frequency f1 is generated at the input point A. The predetermined frequency f1 of the first rectangular wave is equal to the predetermined frequency f1 when the control signal S1 is turned on. The predetermined frequency f1 is, for example, 100kHz.

An amplitude of the first rectangular wave is determined by a resistor divided voltage (divided potential) at the input point A. The input point A is a voltage dividing point where the power supply voltage VE is divided by the two resistors R2 and R3. That is, the amplitude of the first rectangular wave is determined by a potential of the voltage dividing point where the power supply voltage VE is divided by the plurality of resistors R2 and R3.

The shift-up circuit 83 generates a second rectangular wave obtained by shifting up a voltage level of the first rectangular wave. The capacitor C1 is provided in the shift-up circuit 83. The shift-up circuit 83 has an input point A that receives the first rectangular wave and an output point B that outputs the second rectangular wave. The capacitor C1 is coupled between the input point A and the output point B. The second rectangular wave has the same amplitude as the amplitude of the first rectangular wave, and has a voltage level higher than a voltage level of the first rectangular wave by a voltage (boosted voltage) corresponding to the charges accumulated in the capacitor C1. The second line L2 is a line that applies the power supply voltage VE to the output point B. The second line L2 is provided with a diode D1 whose forward direction is a direction toward the output point B.

The shift-up circuit 83 performs shift-up by charging the capacitor C1 by a potential difference between an input potential of the input point A when the switching element Q1 is turned on and an output potential of the output point B when the switching element Q1 is turned on.

The rectifier circuit 84 rectifies the second rectangular wave. The rectifier circuit 84 rectifies a rectangular wave of about 100 kHz and of a potential Vb, which is an output of the shift-up circuit 83. The rectifier circuit 84 includes a diode D2 and a smoothing capacitor C2. The diode D2 is coupled in a direction in which a direction from the output point B toward a ground at the ground voltage Vgrd is a forward direction. The rectifier circuit 84 is, for example, a half-wave rectifier circuit including one diode D2 and the smoothing capacitor C2, or may be a full-wave rectifier circuit.

The rectifier circuit 84 rectifies the second rectangular wave (see FIG. 9) of about 100 kHz and of a potential Vb into a direct current having a potential Vr = (VE + ΔVc). The second rectangular wave of the potential Vb is rectified to a voltage Vr (see FIG. 9) substantially equal to the maximum potential by the rectifier circuit 84. In the example shown in FIG. 9, the second rectangular wave is rectified to a direct current having a potential Vr of about 40 V. An output terminal of the rectifier circuit 84 is coupled to an input terminal of the constant voltage circuit 85.

The graph shown in FIG. 9 shows how the rectangular wave is boosted (shifted up) and a DC voltage Vr after rectification. In this graph, a horizontal axis represents time (second) and a vertical axis represents voltage (V). Va is a potential of a first rectangular wave SW1 at the point A. An amplitude of the first rectangular wave SW1 is a difference between a maximum potential (first potential) and a minimum potential of a potential Va. The maximum potential of the potential Va of the first rectangular wave is substantially equal to a potential of the power supply voltage VE, and is, for example, about 25 V. The minimum potential of the potential Va of the first rectangular wave SW1 is equal to a resistor divided voltage of the two resistors R2 and R3, and is, for example, about 10 V. The amplitude of the first rectangular wave SW1 is equal to a difference between the power supply voltage VE and the resistor divided voltage. The amplitude of the first rectangular wave SW1 is, for example, about 15 V.

Vb shown in FIG. 9 is a potential of a second rectangular wave SW2 at the output point B. The potential Vb of the second rectangular wave SW2 is shifted up with respect to the first rectangular wave SW1 by a voltage equal to the amplitude of the first rectangular wave SW1. The voltage boosted by the shift-up is determined by the amplitude of the first rectangular wave SW1. The amplitude of the first rectangular wave SW1 is determined by the resistor divided voltage of the plurality of resistors R2 and R3. That is, a voltage to be boosted is determined by adjusting the resistor divided voltage of the plurality of resistors R2 and R3. Therefore, it is easy to set the target second DC voltage J2.

As can be seen from the graph shown in FIG. 9, the potential Va of the input point A decreases to about 10 V, which is a resistor divided voltage, when the switching element Q1 is turned on, and increases to the power supply voltage VE (about 25 V) when the switching element Q1 is turned off. The potential Vb of the output point B is shifted up from the potential Va of the input point A by a potential difference ΔVc caused by charges stored in the capacitor C1. Therefore, the voltage decreases to about (10 + ΔVc) V when the switching element Q1 is turned on, and the voltage increases to about (25 + ΔVc) V when the switching element Q1 is turned off. As shown in FIG. 9, the potential Vb of the output point B decreases to about 25 V when the switching element Q1 is turned on, and increases to about 40 V when the switching element Q1 is turned off. The second rectangular wave SW2 is generally boosted by a voltage (about 15 V) corresponding to the amplitude of the first rectangular wave SW1.

As described above, the booster circuit 81 including the capacitor C1 generates, at the output point B, the second rectangular wave SW2 having the maximum potential of a high voltage VE + ΔVc, which is higher than the power supply voltage VE by the potential difference ΔVc of the charged capacitor C1.

The predetermined frequency f1 of the rectangular wave of the control signal S1 may be changed to a value within an appropriate range according to the capacitance of the capacitor C1 or the like. The predetermined frequency f1 is, for example, a value within a range of 1 kHz to 1000 kHz. The predetermined frequency f1 may be, for example, a value within a range of 10 Hz to 1 kHz. The duty of the rectangular wave is, for example, 50%, but may be a value exceeding 50% or a value less than 50%. The duty of the rectangular wave may be, for example, a value within a range of 20% to 80%.

### Configuration of First Voltage Generation Circuit CA1

Next, the configuration of the first voltage generation circuit CA1 will be described with reference to FIG. 7. The first voltage generation circuit CA1 includes the constant voltage circuit 85 and the low-pass filter circuit 86.

The constant voltage circuit 85 is a stabilization circuit that generates the first DC voltage J1 from the power supply voltage VE input via the booster circuit 81 that is being stopped in the reception drive mode. The constant voltage circuit 85 includes the changeover switch Q2, a resistor R4, a limiting resistor R5, and a Zener diode D3. The changeover switch Q2 is implemented by a transistor which is a switching element. The voltage V3 of the control signal S3 is applied to a base terminal of the changeover switch Q2 via the resistor R4.

The limiting resistor R5, the Zener diode D3, and the changeover switch Q2 are coupled in series. The Zener diode D3 has a cathode coupled to a positive electrode (+) and an anode coupled to a negative electrode (-) so that a reverse voltage is applied. A coupling point between the limiting resistor R5 and the Zener diode D3 is a bias point where the control circuit 80 outputs a bias voltage Vbs. A resistance value of the limiting resistor R5 is set to a value at which the bias voltage Vbs can be made equal to a Zener voltage by a Zener current flowing through the Zener diode D3 in consideration of load resistance and the like of the constant voltage circuit 85.

When the control signal S3 is turned on in the reception drive mode, the changeover switch Q2 is turned on. At this time, a Zener current flows through the Zener diode D3, so that the bias potential Vbs becomes equal to the Zener voltage. That is, when the changeover switch Q2 is turned on, the constant voltage circuit 85 generates the first DC voltage J1, which is a constant DC voltage equal to the Zener voltage, as the bias voltage Vbs.

In the high electric field drive mode, since the control signal S3 is turned off, the changeover switch Q2 is in an OFF state. The bias voltage Vbs at this time is equal to the DC voltage Vr which is an output voltage of the rectifier circuit 84. The bias voltage Vbs having a different voltage depending on a mode is input to the low-pass filter circuit 86.

The low-pass filter circuit 86 removes noises of a high frequency equal to or higher than a cutoff frequency from the bias voltage Vbs which is the input DC voltage. The low-pass filter circuit 86 includes a resistor R6 and a capacitor C3. That is, the low-pass filter circuit 86 is an RC filter. The low-pass filter circuit 86 may further include a resistor R7. One end of the resistor R6 is coupled to a bias point, and the other end of the resistor R6 is coupled to one end of the resistor R7. That is, the two resistors R6 and R7 are coupled in series. The capacitor C3 has one end coupled to a coupling point of the two resistors R6 and R7 and the other end grounded. The other end of the resistor R7 is an output terminal of the control circuit 80. The low-pass filter circuit 86 outputs a DC voltage Vd obtained by removing the high-frequency noises from the bias voltage Vbs. An output terminal of the control circuit 80 is coupled to the first electrode 67 (see FIG. 4) of the ultrasonic reception element 61B.

The DC voltage Vd output from the control circuit 80 in the high electric field drive mode is the second DC voltage J2 higher than the power supply voltage VE. The DC voltage Vd output from the control circuit 80 in the reception drive mode is the first DC voltage J1 equal to or lower than the power supply voltage VE. Therefore, the ground voltage Vgrd which is an example of a reference voltage Vo, the first DC voltage J1, the power supply voltage VE, and the second DC voltage J2 satisfy the following magnitude relationship.

Vgrd < J1 < VE < J2

The reference voltage Vo (reference potential) is a low-potential-side voltage of the control circuit 80. In the present embodiment, the reference voltage Vo is, for example, the ground voltage Vgrd (ground potential). The reference voltage Vo is also equal to a low-potential-side voltage of the power supply circuit 72, which is an example of a power supply.

### Voltage Control Method of Ultrasonic Reception Element 61B

The first embodiment includes a voltage control method of the ultrasonic reception element 61B. The voltage control method of the ultrasonic reception element 61B is a method of controlling the power supply voltage VE supplied from the power supply circuit 72, which is an example of a power supply, to switch the DC voltage Vd applied to the ultrasonic reception element 61B in the ultrasonic detection device 70 including the ultrasonic transmission element 61A that transmits ultrasonic waves and the ultrasonic reception element 61B that receives ultrasonic waves.

The voltage control method of the ultrasonic reception element 61B includes the following (A1) and (A2).

(A1) The first DC voltage equal to or lower than the power supply voltage VE is generated at a detection period when the ultrasonic reception element 61B receives ultrasonic waves.

(A2) The second DC voltage J2 higher than the power supply voltage VE is generated at a non-detection period when the ultrasonic reception element 61B does not receive ultrasonic waves.

The generation of the second DC voltage J2 in the above (A2) includes the following (A21), (A22), and (A23).

(A21) The first rectangular wave SW1 having an amplitude equal to or lower than the power supply voltage VE is generated.

(A22) The second rectangular wave SW2 obtained by shifting up a voltage level of the first rectangular wave SW1 is generated.

(A23) The second rectangular wave SW2 is rectified.

The shift-up in the above (A22) is performed based on the potential difference ΔVc caused by charges accumulated in the capacitor C1 coupled between the input point A that receives the first rectangular wave SW1 and the output point B that outputs the second rectangular wave SW2.

### Effects of First Embodiment

The high electric field drive mode is set when the power supply is turned on. The control unit 50 turns on the control signal S2, turns on the control signal S1, and turns off the control signal S3. The control circuit 80 receives the power supply voltage VE as the supply voltage V2. When the changeover switch Q2 is turned off, the second voltage generation circuit CA2 is switched to be an effective circuit. The switching element Q1 is turned on or off at about 100 kHz.

The potential Va based on a rectangular wave of about 100 kHz is level-shifted (shifted up) to the potential Vb of a high potential by ΔVc corresponding to charges stored in the capacitor C1 (see FIG. 9). The second rectangular wave SW2 of about 100kHz and of a potential Vb is rectified into a DC voltage having a constant voltage Vr by the rectifier circuit 84. After high-frequency noises are removed from the DC voltage of the constant potential Vr by the low-pass filter circuit 86, the second DC voltage J2 higher than the power supply voltage VE is applied to the ultrasonic reception element 61B. When the second DC voltage J2 is applied to the ultrasonic reception element 61B, a decrease in sensitivity is prevented.

Meanwhile, at a multiple feeding detection period, the reception drive mode is set. The control unit 50 turns on the control signal S2, turns off the control signal S1, and turns on the control signal S3. Since the switching element Q1 is turned off, the power supply voltage VE is input to the constant voltage circuit 85 via the booster circuit 81 that is being stopped. The constant voltage circuit 85 generates the bias voltage Vbs equal to the Zener voltage of the Zener diode D3. The bias potential Vbs corresponds to the first DC voltage J1. The first DC voltage J1 from which the high-frequency noises are removed by the low-pass filter circuit 86 is applied to the ultrasonic reception element 61B. In this state, the ultrasonic reception element 61B performs multiple feeding detection processing of detecting multiple feeding of the document 14 fed to the conveyance path 29 when the ultrasonic reception element 61B receives ultrasonic waves from the ultrasonic transmission element 61A.

At this time, a high electric field corresponding to the second DC voltage J2 is applied to the ultrasonic reception element 61B by the high electric field drive mode performed before the multiple feeding detection processing. Therefore, the ultrasonic reception element 61B is maintained at high sensitivity.

According to the embodiment, the following effects can be obtained.

(1-1) The control circuit 80 is provided in the ultrasonic detection device 70 including an ultrasonic transmission element that transmits an ultrasonic wave and a piezoelectric ultrasonic reception element that receives an ultrasonic wave. The control circuit 80 controls the power supply voltage supplied from the power supply to switch the DC voltage to be applied to the ultrasonic reception element. The control circuit 80 includes the first voltage generation circuit CA1 that generates the first DC voltage J1 equal to or lower than the power supply voltage VE, and the second voltage generation circuit CA2 that generates the second DC voltage J2 higher than the power supply voltage VE. The control circuit 80 includes the changeover switch Q2 that switches one of the first voltage generation circuit CA1 and the second voltage generation circuit CA2 as an effective circuit configured to generate the DC voltage.

The second voltage generation circuit CA2 includes the booster circuit 81 that boosts the power supply voltage VE to the second DC voltage J2. The booster circuit 81 includes the capacitor C1 that accumulates charges for boosting when the second voltage generation circuit CA2 is switched to be effective. The booster circuit 81 boosts the power supply voltage VE to the second DC voltage J2 using a potential difference ΔVc between both sides of the capacitor C1. According to this configuration, the first DC voltage J1 equal to or lower than the power supply voltage VE and the second DC voltage J2 higher than the power supply voltage VE can be generated as the DC voltage Vd to be applied to the ultrasonic reception element 61B with a simple circuit configuration. Therefore, even with the low power supply voltage VE that is lower than the second DC voltage J2, the second DC voltage J2 higher than the power supply voltage VE can be generated with a simple circuit configuration. For example, a decrease in sensitivity of the ultrasonic reception element 61B can be reduced by performing the high electric field drive mode in which the second DC voltage J2 is applied to the ultrasonic reception element 61B. In particular, the control circuit 80 can be manufactured with a simple configuration and at low cost as compared with a control circuit that boosts a voltage using a coil.

(1-2) The ultrasonic reception element 61B includes the piezoelectric element 65 stacked on the vibration plate 64. The piezoelectric element 65 includes the first electrode 67, the second electrode 69 facing the first electrode 67, and the piezoelectric body 68 interposed between the first electrode 67 and the second electrode 69. When the ultrasonic reception element 61B receives a ultrasonic wave, the piezoelectric element 65 is driven in the reception drive mode in which the first DC voltage J1, which is obtained by applying an electric field of a first electric field intensity to the piezoelectric body 68, is applied between the first electrode 67 and the second electrode 69. Before the execution of the reception drive mode, the piezoelectric element 65 is driven in the high electric field drive mode in which the second DC voltage J2, which is obtained by applying an electric field of a second electric field intensity higher than the first electric field intensity to the piezoelectric body 68, is applied between the first electrode 67 and the second electrode 69.

(1-3) The booster circuit 81 applies a positive first potential lower than the power supply voltage to the input point A which is one of coupling points on both sides of the capacitor C1. The capacitor C1 is charged by applying a second potential higher than the first potential and equal to or lower than the power supply voltage VE to the output point B which is the other coupling point on both sides of the capacitor C1. After the capacitor C1 is charged, the first potential of the input point A is switched to a third potential higher than the first potential and equal to or lower than the power supply voltage VE, thereby boosting the second potential of the output point B to a fourth potential obtained by adding the potential difference ΔVc between both sides of the charged capacitor C1 to the second potential. Accordingly, the second DC voltage F1 is generated. According to this configuration, the first DC voltage J1 equal to or lower than the power supply voltage VE and the second DC voltage J2 higher than the power supply voltage VE can be generated as the DC voltage Vd to be applied to the ultrasonic reception element 61B with a simple circuit configuration.

(1-4) The booster circuit 81 includes the rectangular wave generation circuit 82, the shift-up circuit 83, and the rectifier circuit 84. The rectangular wave generation circuit 82 generates the first rectangular wave SW1 having an amplitude equal to or lower than the power supply voltage VE. The shift-up circuit 83 generates the second rectangular wave SW2 obtained by shifting up a voltage level of the first rectangular wave SW1. The capacitor C1 is provided in the shift-up circuit 83. The shift-up circuit 83 has the input point A that receives the first rectangular wave SW1 and the output point B that outputs the second rectangular wave SW2. The capacitor C1 is coupled between the input point A and the output point B. The second rectangular wave SW2 has the same amplitude as the amplitude of the first rectangular wave SW1, and has a voltage level higher than a voltage level of the first rectangular wave SW1 by a voltage (boosted voltage) corresponding to the charges accumulated in the capacitor C1. The rectifier circuit 84 rectifies the second rectangular wave SW2. According to this configuration, since the second rectangular wave SW2 is generated by shifting up the voltage level of the first rectangular wave SW1 using a voltage based on the charges accumulated in the capacitor C1, the second DC voltage J2 can be generated by rectifying the second rectangular wave SW2. Therefore, the first DC voltage J1 equal to or lower than the power supply voltage and the second DC voltage J2 higher than the power supply voltage VE can be applied to the ultrasonic reception element 61B with a simple circuit configuration. The second DC voltage can be applied to the ultrasonic reception element with a power supply voltage lower than the second DC voltage and a simple circuit configuration. For example, it is possible to provide a control circuit capable of preventing a decrease in sensitivity of the ultrasonic reception element.

(1-5) The rectangular wave generation circuit 82 includes the plurality of (for example, two) resistors R2 and R3 that divide the power supply voltage VE at the input point A. The amplitude of the first rectangular wave SW1 is determined by a potential of the input point A. The input point A is a voltage dividing point where the power supply voltage VE is divided by the two resistors R2 and R3.

That is, the amplitude of the first rectangular wave SW1 is determined by a potential of the voltage dividing point where the power supply voltage VE is divided by the plurality of resistors R2 and R3. According to this configuration, the power supply voltage VE is boosted to the second DC voltage J2 by adjusting the divided potential at the input point A where the power supply voltage VE is divided by the plurality of resistors R2 and R3. The boosted voltage can be controlled.

(1-6) The control circuit 80 includes the power supply line LE to which a power supply voltage VE is supplied, the first line L1 coupled to the power supply line LE, and the second line L2 coupled to the power supply line LE. The first line L1 is a line on which the plurality of resistors R2 and R3 and the input point A are located. The second line L2 is a line that applies the power supply voltage VE to the output point B. The second line L2 is provided with the diode D1 whose forward direction is a direction toward the output point B. According to this configuration, since charges temporarily accumulated in the capacitor C1 are less likely to be discharged, it is possible to quickly boost a voltage, and it is possible to maintain a state in which the second DC voltage J2 is applied to the ultrasonic reception element 61B even after the supply of the power supply voltage VE is stopped.

(1-7) The rectangular wave generation circuit 82 includes the switching element Q1 coupled to the first line L1. The switching element Q1 is turned on and off at the predetermined frequency f1 to generate the first rectangular wave SW1. The shift-up circuit 83 performs shift-up by charging the capacitor C1 by a potential difference between an input potential of the input point A when the switching element Q1 is turned on and an output potential of the output point B when the switching element Q1 is turned on.

According to this configuration, the first rectangular wave SW1 can be generated by the control of turning on or off the switching element Q1 at the predetermined frequency f1, and the first rectangular wave SW1 can be shifted up to the second rectangular wave SW2 by charging the capacitor C1 provided in the shift-up circuit 83. Therefore, the second DC voltage J2 higher than the power supply voltage VE can be generated with a simple circuit configuration.

(1-8) The reference voltage Vo, the first DC voltage J1, the power supply voltage VE, and the second DC voltage J2 satisfy a magnitude relationship of Vo < J1 < VE < J2. According to this configuration, the first DC voltage J1 higher than the reference voltage Vo such as the ground voltage Vgrd (for example, 0 V) and lower than the power supply voltage VE and the second DC voltage J2 higher than the power supply voltage VE can be applied to the ultrasonic reception element 61B. For example, it is not necessary to provide a power supply capable of supplying the power supply voltage VE equal to or higher than the second DC voltage J2.

(1-9) The ultrasonic detection device 70 includes the ultrasonic transmission element 61A, the ultrasonic reception element 61B, and the control circuit 80. According to this configuration, it is possible to reduce a decrease in sensitivity of the ultrasonic reception element 61B with a simple circuit configuration.

(1-10) The conveyance device 30 includes the conveyance unit 31 that conveys the document 14 along the conveyance path 29, the ultrasonic sensor 47 including the ultrasonic transmission element 61A and the ultrasonic reception element 61B disposed to face each other across the conveyance path 29, the control circuit 80, and the control unit 50 that controls the control circuit 80 and the conveyance unit 31. According to this configuration, when the document 14 conveyed along the conveyance path 29 is detected by the ultrasonic sensor 47, it is possible to reduce a decrease in sensitivity of the ultrasonic sensor 47 with a simple circuit configuration.

(1-11) The image reading device 11 which is an example of an image processing device includes the conveyance device 30, the image reading unit 40 which is an example of an image processing unit, and the medium sensor 46. The image reading unit 40 executes image reading processing of reading an image of the document 14 as processing related to an image on the document 14 conveyed along the conveyance path 29. The medium sensor 46 detects the document 14, which is conveyed along the conveyance path 29, at a position upstream of the image reading unit 40 in the conveyance path 29. The ultrasonic sensor 47 is positioned upstream of the medium sensor 46 in the conveyance path 29. According to this configuration, multiple feeding of the documents 14 can be detected at a position upstream of the medium sensor 46 in the conveyance path 29. The multiple feeding of the documents 14 can be detected before the multiple fed documents 14 reach a position of the medium sensor 46. Therefore, multiple feeding can be detected at an early stage after the conveyance of the document 14 is started.

(1-12) The first embodiment includes a voltage control method of the ultrasonic reception element 61B. The voltage control method of the ultrasonic reception element 61B is a method of controlling the power supply voltage VE supplied from the power supply circuit 72, which is an example of a power supply, to switch the DC voltage Vd to be applied to the ultrasonic reception element 61B in the ultrasonic detection device 70 including the ultrasonic transmission element 61A that transmits ultrasonic waves and the ultrasonic reception element 61B that receives ultrasonic waves. The voltage control method of the ultrasonic reception element 61B includes the following (A1) and (A2).

(A1) The first DC voltage equal to or lower than the power supply voltage VE is generated at a detection period when the ultrasonic reception element 61B receives ultrasonic waves.

(A2) The second DC voltage J2 higher than the power supply voltage VE is generated at a non-detection period when the ultrasonic reception element 61B does not receive ultrasonic waves.

The generation of the second DC voltage J2 in the above (A2) includes the following (A21), (A22), and (A23).

(A21) The first rectangular wave SW1 having an amplitude equal to or lower than the power supply voltage VE is generated.

(A22) The second rectangular wave SW2 obtained by shifting up a voltage level of the first rectangular wave SW1 is generated.

(A23) The second rectangular wave SW2 is rectified.

The shift-up in the above (A22) is performed based on the potential difference ΔVc caused by charges accumulated in the capacitor C1 coupled between the input point A that receives the first rectangular wave SW1 and the output point B that outputs the second rectangular wave SW2. According to this method, the first DC voltage J1 equal to or lower than the power supply voltage VE and the second DC voltage J2 higher than the power supply voltage VE can be generated as the DC voltage Vd to be applied to the ultrasonic reception element 61B with a simple circuit configuration.

### Second Embodiment

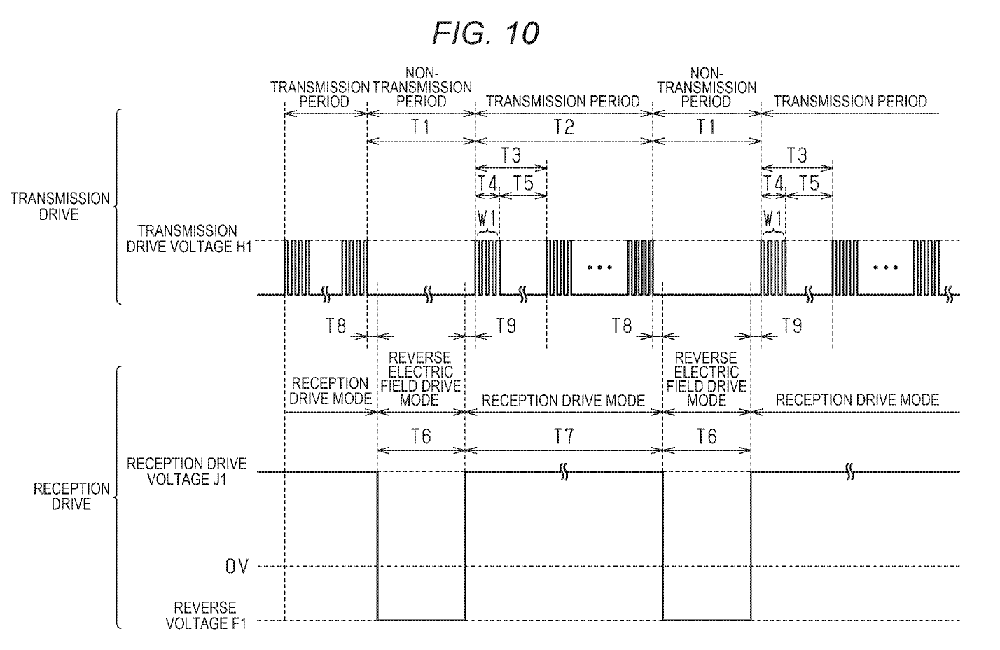

Next, a second embodiment of an image reading device will be described with reference to FIGS. 10 to 13. The second embodiment is different from the first embodiment in that a low electric field drive mode is provided as another mode of the reception drive mode. Since the configuration and the electrical configuration of the image reading device 11 are the same as those in the first embodiment, the same components as those of the first embodiment are denoted by the same reference numerals, and detailed description thereof will be omitted. Hereinafter, differences from the first embodiment will be described in detail.

### Transmission Drive and Reception Drive

First, the transmission drive and the reception drive in the second embodiment will be described with reference to FIG. 10. As shown in FIG. 10, in the transmission drive, a non-transmission period and a transmission period are alternately repeated. A time of the non-transmission period is a time T1. A time of the transmission period is a time T2. The non-transmission period is a period in which a drive signal is not output. The transmission period is a period in which a drive signal for transmission drive is output. In the drive signal for transmission drive, a signal waveform W1 of a burst wave is repeated in a cycle of a time T3 in the transmission period. The transmission period is a period in which the drive signal of the burst wave is output. In the transmission period, the signal waveform W1 is repeated at a cycle of a time T3.

A time T4 at which the signal waveform W1 of the burst wave appears in the time T3 is a transmission drive period. A time T5 between two consecutive signal waveforms W1 is a non-transmission drive period. A period obtained by subtracting the transmission drive period from the time T3 is the non-transmission drive period.

The reception drive in the present embodiment includes a reception drive mode and a reverse electric field drive mode. The reception drive mode and the reverse electric field drive mode are alternately repeated. The reverse electric field drive mode is performed corresponding to the non-transmission period of the transmission drive. The reverse electric field drive mode is performed for each non-transmission period of the transmission drive.

A time of the reverse electric field drive mode is a time T6. The reception drive mode is performed corresponding to the transmission period of the transmission drive. The reception drive mode is performed for each transmission period of the transmission drive. A time of the reception drive mode is a time T7. The time T3, the time T1, the time T2, the time T6, and the time T7 satisfy a magnitude relationship of T7 > T2 > T1 > T6 > T3.

The reverse electric field drive mode is a mode in which an electric field in a direction reverse to a direction of an electric field applied to the piezoelectric body 68 in the reception drive mode is applied to the piezoelectric body 68. The reverse electric field drive mode is achieved by switching potential levels of the first electrode 67 and the second electrode 69 of the piezoelectric element 65.

In other words, the reverse electric field drive mode is achieved by switching a polarity of the potential of the first electrode 67 and a polarity of the potential of the second electrode 69. For example, when the first electrode 67 is a positive electrode and the second electrode 69 is a negative electrode in the reception drive mode, the first electrode 67 is switched to a negative electrode and the second electrode 69 is switched a positive electrode in the reverse electric field drive mode.

In FIG. 10, a voltage in the reverse electric field drive mode is expressed as a reverse voltage F1 in order to show the reverse electric field. In FIG. 10, a voltage value of the reception drive is not an absolute value of a difference between the potential of the first electrode 67 and the potential of the second electrode 69. In FIG. 10, the voltage value of the reception drive indicates a value of a potential of one of the first electrode 67 and the second electrode 69 when a potential of the other one is 0 V. This is equal to a difference between the potential of one of the first electrode 67 and the second electrode 69 and the potential of the other one. An electric field intensity applied to one ultrasonic reception element 61B when the reverse voltage F1 is applied to the reception unit 49 is, for example, a predetermined value within a range of -4 kV/mm to -2 kV/mm. The electric field intensity applied to one ultrasonic reception element 61B may be a value outside this range as long as a reverse electric field can be applied to the piezoelectric body 68.

In the second embodiment, the reverse electric field drive mode of the reception drive starts after a time T8 elapses from the end of the transmission period of the transmission drive. When the time T6 elapses from the start of the reverse electric field drive mode, the reverse electric field drive mode ends. When the reverse electric field drive mode ends, the mode shifts to the reception drive mode. The transmission period of the transmission drive starts after a time T9 elapses from the start of the reception drive mode. In other words, the transmission period of the transmission drive starts after the time T9 elapses from the end of the reverse electric field drive mode. When the time T2 elapses from the start of the transmission period, the transmission period ends.

The reception drive mode ends when the time T8 elapses from the end of the transmission period.

As described above, in the second embodiment, when the ultrasonic reception element 61B does not receive a ultrasonic wave, the piezoelectric element 65 is driven in the reverse electric field drive mode in which the second DC voltage F1, which is obtained by applying an electric field in a direction reverse to a direction of an electric field in the reception drive mode to the piezoelectric body 68, is applied between the first electrode 67 and the second electrode 69. The image reading device 11 in the present embodiment can also perform the control shown in FIG. 10 during an image reading operation of reading an image of the document 14. The conveyance unit 31 conveys the documents 14, which are examples of a medium, one by one. The control unit 50 causes the ultrasonic sensor 47 to execute multiple feeding detection processing of detecting multiple feeding of the documents 14. The control unit 50 controls the control circuit 80 to generate the second DC voltage F1 within a period in which the ultrasonic sensor 47 detects a gap between the preceding document 14 (preceding medium) conveyed first from the conveyance unit 31 and the subsequent document 14 (subsequent medium) conveyed subsequent to the preceding document 14. In the present embodiment, the reverse electric field drive mode is performed within this period.

### Configuration and Operation of Control Circuit 80

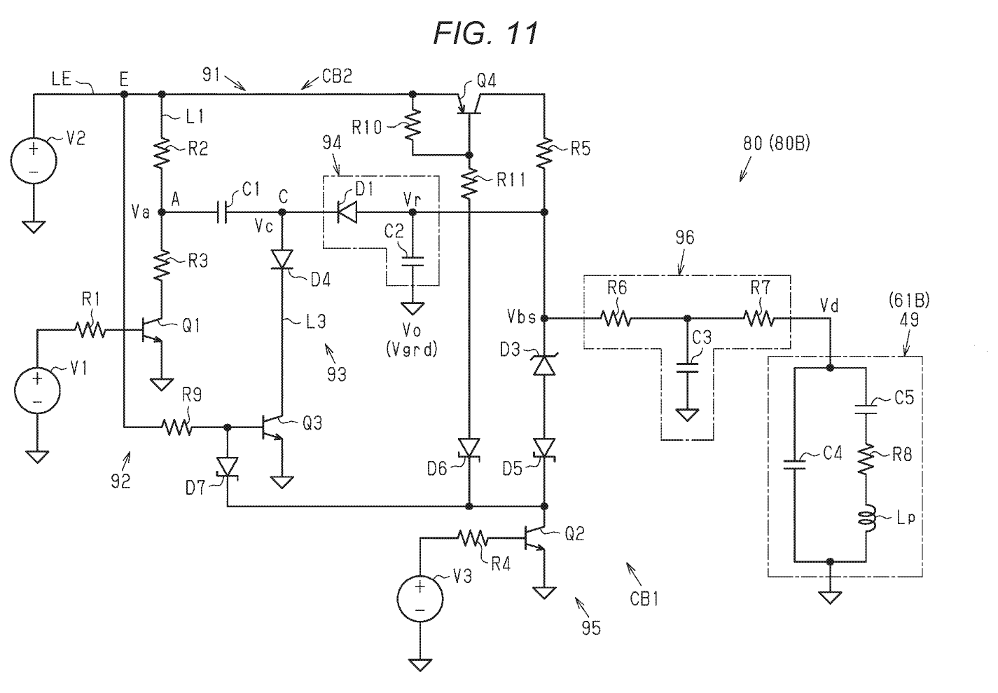

Next, the configuration of the control circuit 80 and an operation of generating the DC voltages J1 and J2 in the second embodiment will be described with reference to FIGS. 11 to 13. To distinguish from the control circuit 80 in the first embodiment, the control circuit 80 in the second embodiment is also referred to as a "second control circuit 80B". The control circuit 80 (second control circuit 80B) is provided in the ultrasonic detection device 70 including the ultrasonic transmission element 61A that transmits ultrasonic waves and the piezoelectric ultrasonic reception element 61B that receives ultrasonic waves. The control circuit 80 controls the power supply voltage VE supplied from a power supply to switch a DC voltage to be applied to the ultrasonic reception element 61B.

The control circuit 80 includes the first voltage generation circuit CB1, the second voltage generation circuit CB2, and the changeover switch Q2. The first voltage generation circuit CB1 generates the first DC voltage J1 equal to or lower than the power supply voltage VE at a detection period when the ultrasonic reception element 61B receives ultrasonic waves. The second voltage generation circuit CB2 generates a negative second DC voltage F1 lower than the reference voltage Vo of the power supply circuit 72, which is an example of a power supply, at a non-detection period when the ultrasonic reception element 61B does not receive ultrasonic waves. The changeover switch Q2 switches one of the first voltage generation circuit CB1 and the second voltage generation circuit CB2 to be an effective circuit configured to generate a DC voltage.

The control circuit 80 shown in FIG. 11 receives the supply voltage V2 from the power supply circuit 72, the voltage V1 of the control signal S1, and the voltage V3 of the control signal S3 from the control unit 50.

The control circuit 80 includes the first voltage generation circuit CB1 that generates the first DC voltage J1 equal to or lower than the power supply voltage VE, and the second voltage generation circuit CB2 that generates the second DC voltage F1 lower than a ground voltage Vgrd, which is an example of a reference voltage. The control circuit 80 includes the changeover switch Q2 that switches one of the first voltage generation circuit CB1 and the second voltage generation circuit CB2 to be an effective circuit configured to generate the DC voltage Vd.

The control circuit 80 generates the DC voltage Vd to be applied to the reception unit 49. In the second embodiment, the control circuit 80 generates a reception drive voltage J1 (the first DC voltage J1) applied to the ultrasonic reception element 61B in the reception drive mode and a reverse voltage F1 (the second DC voltage F1) applied to the ultrasonic reception element 61B in the reverse electric field drive mode. The control circuit 80 applies the generated DC voltage Vd to the ultrasonic reception element 61B. The DC voltage Vd is a bias voltage applied to the ultrasonic reception element 61B. In FIG. 11, the reception unit 49 is shown as an equivalent circuit of the ultrasonic reception element 61B which is a component of the reception unit 49.

### Control Signals S1 and S3 for Controlling Control Circuit 80

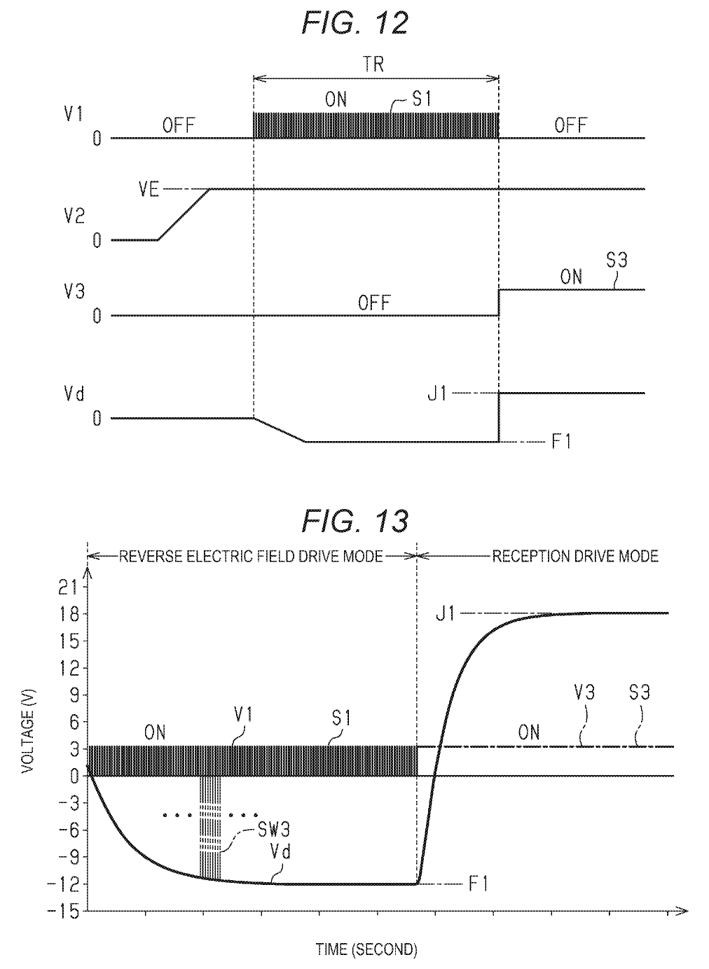

Here, the control signals S1 and S3 for controlling the control circuit 80 will be described with reference to FIGS. 12 and 13. FIG. 12 is a timing chart showing control contents of the control circuit 80.

FIG. 12 shows the voltage V1 of the control signal S1, the supply voltage V2, the voltage V3 of the control signal S3, and the application voltage Vd in order from the top. Each vertical axis represents a voltage value, and each horizontal axis represents time. The voltages V1 to V3 are basically the same as those in the first embodiment. FIG. 13 shows processing of generating the DC voltage Vd in the reverse electric field drive mode and the reception drive mode. In FIG. 13, a second rectangular wave is denoted by a reference numeral "SW3" to be distinguished from the second rectangular wave SW2 in the first embodiment.

When the power supply of the image reading device 11 is turned on, the supply voltage V2 is switched from 0 V to the power supply voltage VE. The voltage V1 of the control signal S1 is 0 V when the control signal S1 is turned off and outputs a rectangular wave of a predetermined frequency f1 when the control signal S1 is turned on. The control signal S1 is turned off in the reception drive mode, and outputs a rectangular wave of a predetermined frequency f1 over a time TR in which the reverse electric field drive mode is performed.

When the control signal S3 is turned off, the second voltage generation circuit CB2 is switched to be effective. In a state where the control signal S3 is turned off, the control signal S1 is turned on in the reverse electric field drive mode. During the time TR in which the reverse electric field drive mode is performed, in which the control signal S1 is turned on, the control signal S1 having a rectangular wave of a predetermined frequency f1 is input to the control circuit 80. At the time TR, the second voltage generation circuit CB2 generates the second DC voltage F1, which is a negative DC voltage lower than the reference voltage Vo, as the DC voltage Vd. In the present embodiment, the reference voltage Vo is 0 V which is the ground voltage Vgrd. Therefore, the DC voltage Vd generated in the reverse electric field drive mode is, for example, the negative second DC voltage F1 (reverse voltage F1 < 0) lower than the ground voltage (Vgrd = 0). The second DC voltage F1 is, for example, about -12 V (see FIG. 13).

As shown in FIGS. 12 and 13, the control signal S3 is switched from OFF to ON in the reception drive mode. In a state where the control signal S3 is turned on, the first voltage generation circuit CB1 is effective.

In the reception drive mode in which both the control signals S1 and S3 are turned off, the first voltage generation circuit CB1 generates the first DC voltage J1 (the reception drive voltage J1) as the DC voltage Vd. The first DC voltage J1 is, for example, about 18 V (see FIG. 13).

### Configuration of Control Circuit 80

Next, the configuration of the control circuits 80 (80B) will be described with reference to FIG. 11.

The second voltage generation circuit CB2 includes a step-down circuit 91 and a low-pass filter circuit 96. The step-down circuit 91 includes a rectangular wave generation circuit 92, a shift-down circuit 93, and a rectifier circuit 94.

The second voltage generation circuit CB2 includes the step-down circuit 91 that steps down the ground voltage Vgrd, which is an example of the reference voltage Vo, to the second DC voltage F1. The step-down circuit 91 includes a capacitor C1 that accumulates charges for step-down when the second voltage generation circuit CB2 is switched to be effective.

The step-down circuit 91 steps down the reference voltage Vo to the second DC voltage F1 using a potential difference between both sides of the capacitor C1.

The step-down circuit 91 has an input point A which is one of coupling points on both sides of the capacitor C1 and an output point C which is the other one of coupling points on both sides of the capacitor C1. The step-down circuit 91 applies a first potential (for example, the power supply voltage VE) equal to or lower than the power supply voltage VE and higher than the reference voltage Vo to the input point A which is one point of both sides of the capacitor C1. The step-down circuit 91 applies a second potential (for example, a voltage Vf) lower than the first potential and equal to or higher than the reference voltage Vo to the output point C which is the other one point of both sides of the capacitor C1. The capacitor C1 is charged by a potential difference between the input point A and the output point C. After the capacitor C1 is charged, the step-down circuit 91 switches the first potential (for example, the power supply voltage VE) of the input point A to a third potential (for example, a resistor divided voltage) lower than the first potential and equal to or higher than the reference voltage Vo. Accordingly, the second DC voltage F1 is generated by stepping down the second potential (for example, Vf) of the output point C to a fourth potential (< Vo) obtained by subtracting a voltage corresponding to a potential difference ΔVc between both sides of the charged capacitor C1 from the second potential.

That is, when the potential of the input point A decreases from the first potential to the third potential, the potential of the output point C decreases from the second potential (for example, Vf) to the fourth potential (< Vo) by an amount of decrease in the potential of the input point A while keeping the potential difference ΔVc of the charged capacitor C1. In this manner, the potential of the output point C decreases from the potential Vf near the reference voltage Vo (for example, 0 V) by an amount corresponding to the decrease in the potential of the input point A. Accordingly, the potential of the output point C is stepped down to the negative fourth potential lower than the reference potential Vo.

The step-down circuit 91 includes the rectangular wave generation circuit 92, the shift-down circuit 93, and the rectifier circuit 94. The rectangular wave generation circuit 92 generates a first rectangular wave SW1 having an amplitude equal to or lower than the power supply voltage VE. That is, the rectangular wave generation circuit 92 generates the first rectangular wave SW1 at the input point A.

The rectangular wave generation circuit 92 includes a plurality of resistors R2 and R3 that divide the power supply voltage VE at the input point A. The control circuit 80 includes a first line L1. The first line L1 is coupled to a power supply line LE to which the power supply voltage VE is supplied. The plurality of resistors R2 and R3 and the input point A are located in series on the first line L1. In the present embodiment, two resistors R2 and R3 are provided as the plurality of resistors. One end of the resistor R2 is coupled to a coupling point E between the power supply line LE and the first line L1, and the other end of the resistor R2 is coupled to one end of the resistor R3. A coupling point between the resistor R2 and the resistor R3 is the input point A.

The rectangular wave generation circuit 92 includes the switching element Q1 coupled to the first line L1. The switching element Q1 is turned on and off at the predetermined frequency f1 to generate the first rectangular wave SW1. The switching element Q1 is coupled to the other end of the resistor R3.

The switching element Q1 includes, for example, a transistor. The voltage V1 of the control signal S1 is applied to a base terminal of the switching element Q1 via the resistor R1. When the control signal S1 is turned on, as the voltage V1, a rectangular wave of a predetermined frequency f1 is input to the base terminal of the switching element Q1, and thus the switching element Q1 repeats ON and OFF at the predetermined frequency f1. Therefore, the first rectangular wave SW1 similar to that of the first embodiment is generated at the input point A. That is, the first rectangular wave SW1 indicated by a one-dot chain line in FIG. 9 is generated at the input point A. A maximum potential of the potential Va of the first rectangular wave SW1 is substantially equal to a potential of the power supply voltage VE, and is, for example, about 25 V. A minimum potential of the potential Va of the first rectangular wave SW1 is equal to a resistor divided voltage of the two resistors R2 and R3. An amplitude of the first rectangular wave SW1 is determined by the resistor divided voltage. Resistance values of the resistors R2 and R3 are determined according to a target value of the second DC voltage F1 (reverse voltage F1) generated by shift-down.

The shift-down circuit 93 generates a second rectangular wave SW3 obtained by shifting down a voltage level of the first rectangular wave SW1. The shift-down circuit 93 has the input point A that receives the first rectangular wave SW1 and the output point C that outputs the second rectangular wave SW3. The shift-down circuit 93 includes the capacitor C1 coupled between the input point A and the output point C. The shift-down circuit 93 includes the capacitor C1 coupled between the input point A that receives the first rectangular wave SW1 and the output point C that outputs the second rectangular wave SW3. That is, the capacitor C1 provided in the step-down circuit 91 is provided in the shift-down circuit 93.

The control circuit 80 includes a second line L3. The second line L3 applies the ground voltage Vgrd to the output point C in which the rectifier circuit 94 is grounded. In the present embodiment, the reference voltage Vo is the ground voltage Vgrd. The rectifier circuit 94 includes a diode D1 and a smoothing capacitor C2. The diode D1 is coupled in a direction in which a direction from the ground at the ground voltage Vgrd (= 0) toward the output point C is a forward direction.

The shift-down circuit 93 performs shift-down by charging the capacitor C1 by a potential difference between an output potential Vc of the output point C when the switching element Q1 is turned off and an input potential Va of the input point A when the switching element Q1 is turned on.

A step-down voltage for shifting down the potential Vc of the output point C with respect to the input potential Va of the input point A is determined by a divided potential at the input point A. That is, an amplitude of the first rectangular wave SW1 determines the step-down voltage. The amplitude of the first rectangular wave SW1 is a difference between the power supply voltage VE and the resistor divided voltage. A voltage corresponding to the amplitude is a step-down voltage.

The shift-down circuit 93 includes a diode D4 coupled in series to the second line L3 and a switching element Q3. The diode D4 is coupled between the output point C and the switching element Q3. The diode D4 is coupled in a direction in which a direction away from the output point C is a forward direction. That is, the diode D4 has a forward direction from the output point C toward the switching element Q3.

The switching element Q3 is, for example, a transistor. A base voltage obtained by decreasing the power supply voltage VE to a predetermined voltage via a resistor R9 is applied to a base terminal of the switching element Q3. The switching element Q3 is turned on when the supply voltage V2 is the power supply voltage VE. In a case where the potential Vc of the output point C becomes lower than the ground voltage Vgrd when the switching element Q3 is turned on, a current flows from a ground point (Vgrd = 0) of the rectifier circuit 94 toward the output point C. Therefore, the potential Vc of the output point C can be changed. When the potential Vc at the output point C becomes negative, the diode D4 blocks a reverse current flowing from the ground point to the output point C via the switching element Q3.

The rectifier circuit 94 rectifies the second rectangular wave SW3. The rectifier circuit 94 rectifies a rectangular wave of about 100 kHz and of a potential Vb, which is output from the output point C of the shift-down circuit 93. The rectifier circuit 94 includes the diode D1 and the smoothing capacitor C2 described above. The rectifier circuit 94 is, for example, a half-wave rectifier circuit including one diode D1 and the smoothing capacitor C2, or may be a full-wave rectifier circuit.

The reference voltage Vo is denoted by the ground voltage Vgrd, the first DC voltage is denoted by J1, the power supply voltage is denoted by VE, and the second DC voltage is denoted by F1. A magnitude relationship thereof satisfy F1 < Vgrd < J1 < VE.

### Configuration of First Voltage Generation Circuit CB1

Next, the configuration of the first voltage generation circuit CB1 will be described with reference to FIG. 11. The first voltage generation circuit CB1 includes a constant voltage circuit 95 and the low-pass filter circuit 96. The first voltage generation circuit CB1 and the second voltage generation circuit CB2 share the low-pass filter circuit 96.

The low-pass filter circuit 96 has the same circuit configuration as the low-pass filter circuit 86 in the first embodiment.

The constant voltage circuit 95 has a basic circuit configuration similar to that in the first embodiment. Similar to the first embodiment, the constant voltage circuit 95 includes the changeover switch Q2, the resistor R4, the limiting resistor R5, and the Zener diode D3. The constant voltage circuit 95 includes a switching element Q4 as a configuration different from that in the first embodiment. The switching element Q4 is coupled between a coupling point E of the power supply line LE and the limiting resistor R5. The switching element Q4 is, for example, a transistor. A base terminal of the switching element Q4 is coupled to a collector terminal of the changeover switch Q2 via a resistor R11. A resistor R10 is coupled between the base terminal and an emitter terminal of the switching element Q4.

The collector terminal of the changeover switch Q2 is coupled to a base terminal of the switching element Q3. Schottky-diodes D5, D6, and D7 for preventing backflow are provided on three lines coupled in parallel to the collector terminal of the changeover switch Q2.

### Voltage Control Method of Ultrasonic Reception Element 61B

The second embodiment includes a voltage control method of the ultrasonic reception element 61B. The voltage control method of the ultrasonic reception element 61B is a method of controlling the power supply voltage VE supplied from the power supply circuit 72, which is an example of a power supply, to switch the DC voltage Vd to be applied to the ultrasonic reception element 61B in the ultrasonic detection device 70 including the ultrasonic transmission element 61A that transmits ultrasonic waves and the ultrasonic reception element 61B that receives ultrasonic waves.

The voltage control method of the ultrasonic reception element 61B includes the following (B1) and (B2).

(B1) The first DC voltage equal to or lower than the power supply voltage VE is generated at a detection period when the ultrasonic reception element 61B receives ultrasonic waves.

(B2) The negative second DC voltage F1 lower than the reference voltage Vo, which is a low-potential-side voltage of a power supply, is generated at a non-detection period when the ultrasonic reception element 61B does not receive ultrasonic waves.

The generation of the second DC voltage F1 in the above (B2) includes the following (B21), (B22), and (B23).

(B21) The first rectangular wave SW1 having an amplitude equal to or lower than the power supply voltage VE is generated.

(B22) The second rectangular wave SW3 obtained by shifting down a voltage level of the first rectangular wave SW1 is generated.

(B23) The second rectangular wave SW3 is rectified.

The shift-down in the above (B22) is performed based on the potential difference ΔVc generated by charges accumulated in the capacitor C1 coupled between the input point A that receives the first rectangular wave SW1 and the output point C that outputs the second rectangular wave SW3.

### Effects of Second Embodiment

In the reverse electric field drive mode, the control unit 50 turns on the control signal S2, turns on the control signal S1, and turns off the control signal S3. The control circuit 80 receives the power supply voltage VE as the supply voltage V2. When the changeover switch Q2 is turned off, the second voltage generation circuit CA2 is switched to be an effective circuit. Based on the control signal S1, the switching element Q1 is turned on or off at about 100 kHz. At this time, the switching element Q3 is turned on. The output point C is grounded at the reference voltage Vo (Vgrd = 0) via the rectifier circuit 94. The potential Vc of the output point C is initially Vf (about 0.7 V).

The potential Va of the input point A decreases to the resistor divided voltage when the switching element Q1 is turned on, and increases to the power supply voltage VE (about 25 V) when the switching element Q1 is turned off. A rectangular wave of about 100kHz is generated. Since the potential Vc of the output point C is a predetermined potential Vf (for example, Vf = 0.7 V) of substantially 0 V, a potential difference is generated on both sides of the capacitor C1. The capacitor C1 is charged by the potential difference. After the capacitor C1 is charged, the potential Va of the input point A is also used to generate the first rectangular wave SW1.

When the switching element Q1 is turned off, the potential of the input point A becomes the power supply voltage VE. At this time, the potential Vc of the output point C is Vf (about 0.7). Next, when the switching element Q1 is turned on, the potential Va of the input point A decreases to the resistor divided voltage.

Then, the potential Vc of the input point decreases from Vf while keeping the potential difference ΔVc of the capacitor C1 charged earlier. That is, the potential Vc of the output point C decreases by the same voltage as the decrease of the potential Va. In this manner, the second rectangular wave SW3 in which a potential level is shifted down by the potential difference ΔVc of the capacitor C1 with respect to the potential Va of the input point A is output from the output point C. The second rectangular wave SW3 has the same frequency and waveform as the first rectangular wave SW1.

A minimum potential of the second rectangular wave SW3 is Vf - ΔVc, and a maximum potential is Vf. Since Vf < ΔVc, the minimum potential of the second rectangular wave SW3 is a negative potential. Even when the output point C has a negative potential, the diode D4 blocks a current flowing from the switching element Q3 to the output point C, and thus the negative potential of the minimum potential of the output point C is kept. In the first embodiment, the first rectangular wave SW1 is shifted up by the potential difference ΔVc generated by charging the capacitor C1, while in the second embodiment, the second rectangular wave SW3 is generated by shifting down the first rectangular wave SW1 by the potential difference ΔVc generated by charging the capacitor C1. In this manner, the second rectangular wave SW3 is output from the output point C of the shift-down circuit 93.

As shown in FIG. 13, in the reverse electric field drive mode, when the control signal S1 is turned on, the DC voltage Vd decreases while drawing a curve. In this process, the capacitor C1 is charged. In this charging process, an amplitude of the second rectangular wave SW3 approaches the amplitude of the first rectangular wave SW1 (see FIG. 9).

After the charging of the capacitor C1 ends, the amplitude of the second rectangular wave SW3 becomes substantially the same as the amplitude of the first rectangular wave SW1. In the example shown in FIG. 13, the second rectangular wave SW3 has an amplitude, for example, between Vf and about -12 V, and the second DC voltage F1 of about -12 V is generated after rectification and noise removal.

The second rectangular wave SW3 of about 100 kHz and of a potential Vc is rectified to the second DC voltage F1 by the rectifier circuit 94. The second DC voltage F1 is applied to the ultrasonic reception element 61B after high-frequency noises are removed by the low-pass filter circuit 86. The second DC voltage F1 is a reverse voltage (< 0) lower than the ground voltage Vgrd. A decrease in sensitivity of the ultrasonic sensor 47 is reduced by applying the second DC voltage F1 to the ultrasonic reception element 61B. Thereafter, in FIG. 13, when the control signal S1 is turned off and the control signal S3 is turned on, the reception drive mode is set. In the reception drive mode, the first DC voltage J1 is generated by the first voltage generation circuit CB1. A timing of turning off the control signal S1 may be earlier than a timing of turning on the control signal S3.

The reverse electric field drive mode in which the second DC voltage F1 is applied to the ultrasonic reception element 61B is performed at a non-transmission period other than a multiple feeding detection period. Meanwhile, at the multiple feeding detection period, the reception drive mode is set. The control unit 50 turns off the control signal S1 and turns on the control signal S3. As a result, the changeover switch Q2 is turned on and the switching element Q4 is turned on. Then, the constant voltage circuit 85 generates the bias voltage Vbs equal to the Zener voltage of the Zener diode D3.

The bias potential Vbs is equal to the first DC voltage J1. The first DC voltage J1 from which the high-frequency noises are removed by the low-pass filter circuit 86 is applied to the ultrasonic reception element 61B. In this state, the ultrasonic reception element 61B receives ultrasonic waves from the ultrasonic transmission element 61A. In a state where the first DC voltage J1 is applied to the ultrasonic reception element 61B, multiple feeding detection processing of detecting multiple feeding of the documents 14 fed to the conveyance path 29 is executed.

In the second embodiment, as shown in FIG. 10, the reception drive mode is performed in a transmission period, and the reverse electric field drive mode is performed in a non-transmission period. In the reception drive mode, the reception drive voltage J1 (the first DC voltage J1) is applied to the ultrasonic reception element 61B. In the reverse electric field drive mode, the reverse voltage F1 (the second DC voltage F1) is applied to the ultrasonic reception element 61B. The non-transmission period is, for example, a period in which a gap between the preceding document 14 (preceding medium) and the subsequent document 14 (subsequent medium) is in a detection region of the ultrasonic sensor 47. For example, when the image reading unit 40 continuously reads a plurality of the documents 14, the reception drive mode and the reverse electric field drive mode are alternately performed. A period in which the reverse electric field drive mode is performed may be a period between a preceding reading job and a subsequent reading job for the image reading device 11. A reverse electric field corresponding to the second DC voltage F1 is applied to the ultrasonic reception element 61B by a high electric field drive mode performed before the multiple feeding detection processing. Therefore, a decrease in sensitivity of the ultrasonic sensor 47 is reduced.

Therefore, according to the image reading device 11 in the second embodiment, although the circuit configuration of the control circuit 80 is different from that of the first control circuit 80A in the first embodiment, the effects (1-9) to (1-11) of the first embodiment can be similarly obtained, and the following effects can be further obtained.

(2-1) The control circuit 80 (the second control circuit 80B) is provided in the ultrasonic detection device 70 including the ultrasonic transmission element 61A that transmits ultrasonic waves and the piezoelectric ultrasonic reception element 61B that receives ultrasonic waves. The control circuit 80 controls the power supply voltage VE supplied from a power supply to switch a DC voltage to be applied to the ultrasonic reception element 61B.

The control circuit 80 includes the first voltage generation circuit CB1, the second voltage generation circuit CB2, and the changeover switch Q2. The first voltage generation circuit CB1 generates the first DC voltage J1 equal to or lower than the power supply voltage VE at a detection period when the ultrasonic reception element 61B receives ultrasonic waves. The second voltage generation circuit CB2 generates a negative second DC voltage F1 lower than the reference voltage Vo of the power supply circuit 72, which is an example of a power supply, at a non-detection period when the ultrasonic reception element 61B does not receive ultrasonic waves. The changeover switch Q2 switches one of the first voltage generation circuit CB1 and the second voltage generation circuit CB2 to be an effective circuit configured to generate a DC voltage. The second voltage generation circuit CB2 includes the step-down circuit 91 that steps down the power supply voltage VE to the second DC voltage F1. The step-down circuit 91 includes the capacitor C1 that accumulates charges for step-down when the second voltage generation circuit CB2 is switched to be effective.

The step-down circuit 91 steps down the reference voltage Vo to the second DC voltage F1 using a potential difference ΔVc between both sides of the capacitor C1. According to this configuration, the first DC voltage J1 higher than the reference voltage Vo and equal to or lower than the power supply voltage VE and the second DC voltage F1 lower than the reference voltage Vo (for example, the ground voltage) can be generated as a DC voltage to be applied to the ultrasonic reception element 61B with a simple circuit configuration.

(2-2) The ultrasonic reception element 61B includes the piezoelectric element 65 stacked on the vibration plate 64. The piezoelectric element 65 includes the first electrode 67, the second electrode 69 facing the first electrode 67, and the piezoelectric body 68 interposed between the first electrode 67 and the second electrode 69. When the ultrasonic reception element 61B receives a ultrasonic wave, the piezoelectric element 65 is driven in the reception drive mode in which the first DC voltage J1, which is obtained by applying an electric field of a first electric field intensity to the piezoelectric body 68, is applied between the first electrode 67 and the second electrode 69. When the ultrasonic reception element 61B does not receive a ultrasonic wave, the piezoelectric element 65 is driven in the reverse electric field drive mode in which the second DC voltage F1 is applied between the first electrode 67 and the second electrode 69. In the reverse electric field drive mode, an electric field in a direction reverse to a direction of an electric field in the reception drive mode is applied to the piezoelectric body 68. According to this configuration, when the ultrasonic reception element 61B does not receive the ultrasonic wave, the second DC voltage F1, which is obtained by applying the electric field in a direction reverse to the direction of the electric field in the reception drive mode, is applied to the piezoelectric body 68. Therefore, it is possible to reduce a decrease in sensitivity of the ultrasonic reception element 61B without affecting the reception of the ultrasonic wave by the ultrasonic reception element 61B.

(2-3) The step-down circuit 91 applies a first potential equal to or lower than the power supply voltage VE and higher than the reference voltage Vo to the input point A which is one of coupling points on both sides of the capacitor C1. The capacitor C1 is charged by applying a second potential lower than the first potential and equal to or higher than the reference voltage Vo to the output point C which is the other one of the coupling points on both sides of the capacitor C1. After the capacitor C1 is charged, the first potential of the input point A is switched to a third potential lower than the first potential and equal to or higher than the reference voltage Vo. Accordingly, the second DC voltage F1 is generated by stepping down the second potential of the output point C to a fourth potential obtained by subtracting a voltage corresponding to a potential difference ΔVc between both sides of the charged capacitor C1 from the second potential. According to this configuration, it is possible to reduce a decrease in sensitivity of the ultrasonic reception element 61B with a simple circuit configuration without preparing the reference voltage Vo equal to or lower than the second DC voltage F1 which is a negative voltage.

(2-4) The step-down circuit 91 includes the rectangular wave generation circuit 92, the shift-down circuit 93, and the rectifier circuit 94. The rectangular wave generation circuit 92 generates the first rectangular wave SW1 having an amplitude equal to or lower than the power supply voltage VE. The shift-down circuit 93 generates a second rectangular wave SW3 obtained by shifting down a voltage level of the first rectangular wave SW1. The rectifier circuit 94 rectifies the second rectangular wave SW3. The shift-down circuit 93 includes the capacitor C1 coupled between the input point A that receives the first rectangular wave SW1 and the output point C that outputs the second rectangular wave SW3. According to this configuration, since the second rectangular wave SW3 is generated by shifting down the voltage level of the first rectangular wave SW1 using a voltage based on the charges accumulated in the capacitor C1, the second DC voltage F1 can be generated by rectifying the second rectangular wave SW3. Therefore, the first DC voltage J1 equal to or lower than the power supply voltage VE and the second DC voltage F1 higher than the power supply voltage VE can be applied to the ultrasonic reception element 61B with a simple circuit configuration. Even when the power supply voltage VE is higher than the second DC voltage F1, the second DC voltage F1 can be applied to the ultrasonic reception element 61B with a simple circuit configuration. Therefore, a reverse electric field in a direction reverse to a direction of an electric field at the time of reception can be applied to the ultrasonic reception element 61B. For example, a decrease in sensitivity of the ultrasonic reception element 61B can be reduced.

(2-5) The rectangular wave generation circuit 92 includes the plurality of resistors R2 and R3 that divide the power supply voltage VE at the input point A. A step-down voltage is determined by a divided potential at the input point A. According to this configuration, it is possible to control the step-down voltage for stepping down the reference voltage Vo to the second DC voltage F1 by adjusting the divided potential at the input point A where the power supply voltage VE is divided by the plurality of resistors. Therefore, the generated second DC voltage F1 can be determined with a simple configuration. For example, a circuit is easily designed.

(2-6) The control circuit 80 includes the first line L1 and the second line L2. The first line L1 is coupled to the power supply line LE to which the power supply voltage VE is supplied, and the plurality of resistors R2 and R3 and the input point A are located in series on the first line L1. The second line L2 applies the reference voltage Vo to the output point C. The second line L2 is provided with the diode D4 whose forward direction is a direction toward the output point C. According to this configuration, charges temporarily accumulated in the capacitor C1 are prevented from being discharged to the ground or the like by the diode D4. Therefore, a voltage can be quickly stepped down. For example, even when a drive time of the second voltage generation circuit CB2 is short, a sufficient reverse electric field can be applied to the ultrasonic reception element 61B by applying the second DC voltage F1 lower than the reference voltage Vo.

(2-7) The rectangular wave generation circuit 92 includes the switching element Q1 coupled to the first line L1. The switching element Q1 is turned on and off at the predetermined frequency f1 to generate the first rectangular wave SW1. The shift-down circuit 93 performs shift-down by charging the capacitor C1 by a potential difference between an input potential of the input point A when the switching element Q1 is turned on and an output potential of the output point C when the switching element Q1 is turned on. According to this configuration, the first rectangular wave SW1 can be generated by control of turning on and off the switching element Q1 at the predetermined frequency f1, and the first rectangular wave SW1 can be shifted down to the second rectangular wave SW3 by charging the capacitor C1 provided in the shift-down circuit 93. Therefore, the second DC voltage F1 lower than the reference voltage Vo can be generated with a simple circuit configuration.

(2-8) The reference voltage Vo is denoted by the ground voltage Vgrd, the first DC voltage J1 is denoted by J1, the power supply voltage VE is denoted by VE, and the second DC voltage F1 is denoted by F1. A magnitude relationship thereof satisfy F1 < Vgrd < J1 < VE.

According to this configuration, the first DC voltage J1 and the negative second DC voltage F1 lower than the ground voltage Vgrd (for example, 0 V) can be switched and applied to the ultrasonic reception element 61B.

(2-9) The ultrasonic detection device 70 includes the ultrasonic transmission element 61A, the ultrasonic reception element 61B, and the control circuit 80. According to this configuration, it is possible to reduce a decrease in sensitivity of the ultrasonic reception element 61B with a simple circuit configuration.

(2-10) The conveyance device 30 includes the conveyance unit 31 that conveys the document 14 along the conveyance path 29, the ultrasonic sensor 47 including the ultrasonic transmission element 61A and the ultrasonic reception element 61B disposed to face each other across the conveyance path 29, and the control circuit 80. According to this configuration, when the document 14 conveyed along the conveyance path 29 is detected by the ultrasonic sensor 47, it is possible to reduce a decrease in sensitivity of the ultrasonic sensor 47 with a simple circuit configuration.

(2-11) The image reading device 11 which is an example of an image processing device includes the conveyance device 30, the image reading unit 40 which is an example of an image processing unit, and the medium sensor 46. The image reading unit 40 executes image reading processing of reading an image of the document 14 as processing related to an image on the document 14 conveyed along the conveyance path 29. The medium sensor 46 detects the document 14, which is conveyed along the conveyance path 29, at a position upstream of the image reading unit 40 in the conveyance path 29. The ultrasonic sensor 47 is positioned upstream of the medium sensor 46 in the conveyance path 29. According to this configuration, multiple feeding of the documents 14 can be detected at a position upstream of the medium sensor 46 in the conveyance path 29. The multiple feeding of the documents 14 can be detected before the multiple fed documents 14 reach a position of the medium sensor 46. Therefore, multiple feeding can be detected at an early stage after the conveyance of the document 14 is started.

(2-12) The conveyance unit 31 conveys the documents 14 one by one. The control unit 50 that controls the control circuit 80 causes the ultrasonic sensor 47 to execute the multiple feeding detection processing of detecting multiple feeding of the documents 14.

The control unit 50 controls the control circuit 80 (80B) to generate the second DC voltage F1 within a period in which the ultrasonic sensor 47 detects a gap between the preceding document 14 (preceding medium) conveyed first from the conveyance unit 31 and the subsequent document 14 (subsequent medium) conveyed subsequent to the preceding document 14. Accordingly, the control unit 50 performs the reverse electric field drive mode. According to this configuration, since the reverse electric field drive mode is performed within a period in which the gap between the preceding medium and the subsequent medium is detected, it is possible to perform multiple feeding detection of the documents 14 while reducing a decrease in sensitivity.

(2-13) The second embodiment includes a voltage control method of the ultrasonic reception element 61B. The voltage control method of the ultrasonic reception element 61B is a method of controlling the power supply voltage VE supplied from the power supply circuit 72, which is an example of a power supply, to switch the DC voltage Vd to be applied to the ultrasonic reception element 61B in the ultrasonic detection device 70 including the ultrasonic transmission element 61A that transmits ultrasonic waves and the ultrasonic reception element 61B that receives ultrasonic waves. The voltage control method of the ultrasonic reception element 61B includes the following (B1) and (B2).

(B1) The first DC voltage J1 equal to or lower than the power supply voltage VE is generated at a detection period when the ultrasonic reception element 61B receives ultrasonic waves.

(B2) The negative second DC voltage F1 lower than the reference voltage Vo, which is a low-potential-side voltage of a power supply, is generated at a non-detection period when the ultrasonic reception element 61B does not receive ultrasonic waves.

The generation of the second DC voltage F1 in the above (B2) includes the following (B21), (B22), and (B23).

(B21) The first rectangular wave SW1 having an amplitude equal to or lower than the power supply voltage VE is generated.

(B22) The second rectangular wave SW3 obtained by shifting down a voltage level of the first rectangular wave SW1 is generated.

(B23) The second rectangular wave SW3 is rectified.

The shift-down in the above (B22) is performed based on the potential difference ΔVc generated by charges accumulated in the capacitor C1 coupled between the input point A that receives the first rectangular wave SW1 and the output point C that outputs the second rectangular wave SW3. According to this method, the first DC voltage J1 equal to or lower than the power supply voltage VE and the negative second DC voltage F1 lower than the reference voltage Vo (for example, the ground voltage Vgrd) of a power supply can be generated as a DC voltage to be applied to the ultrasonic reception element 61B with a simple circuit configuration.

The above embodiment may be modified as the following modifications. Further, an appropriate combination of the above described embodiment and the following modifications can be used as another modification, and an appropriate combination of the following modifications can be used as another modification.

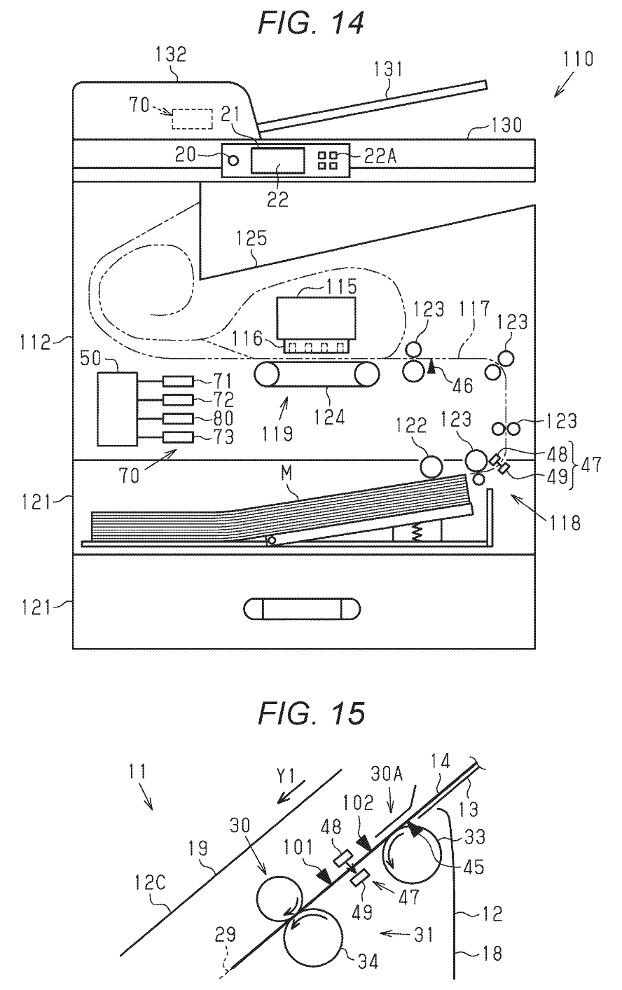

As shown in FIG. 14, an image processing device including the ultrasonic detection device 70 is not limited to the image reading device 11, and may be, for example, an image forming device 110. The image forming device 110 executes image forming processing of forming an image on a medium M as processing related to an image on the medium M conveyed along a conveyance path 117. The image forming device 110 includes an image forming unit 115 that forms an image on the medium M as an example of an image processing unit. The image forming device 110 forms an image using the medium M. The image forming device 110 may be, for example, an inkjet printer. The image forming device 110 includes a display unit 22 and an operation unit 22A at an upper portion of a main body 112. The display unit 22 may be implemented by, for example, a touch panel. The image forming device 110 may include a power button 20. The image forming unit 115 includes, for example, an ejection head 116 that ejects ink. The image forming unit 115 prints an image on the medium M conveyed along the conveyance path 117 in the main body 112. That is, the image forming device 110 forms an image on the medium M by printing. The image forming device 110 is also a liquid ejection device that ejects ink, which is an example of a recording material, toward the medium M. The medium M is, for example, a sheet. One or more cassettes 121 are detachably inserted into a lower portion of the main body 112. A plurality of media M are accommodated in the cassette 121 in a stacked state. The image forming device 110 includes a conveyance device 118. The conveyance device 118 includes a conveyance unit 119 that conveys the medium M along the conveyance path 117, the control circuit 80, and the control unit 50 that controls the conveyance unit 119 and the control circuit 80. The conveyance unit 119 includes a conveyance belt 124 and a plurality of rollers 122 and 123 disposed at positions along the conveyance path 117. The conveyance unit 119 conveys the media M in the cassette 121 one by one along the conveyance path 117 by the plurality of rollers 122,123 and the conveyance belt 124. The medium M on which an image is formed by the image forming unit 115 at an image forming position in an intermediate portion of the conveyance path 117 is discharged to a stacker 125 provided at an upper portion of the main body 112. The conveyance device 118 includes the medium sensor 46 located upstream of the image forming unit 115 in the conveyance path 117 and the ultrasonic sensor 47 located upstream of the medium sensor 46 in the conveyance path 117. The ultrasonic sensor 47 includes the transmission unit 48 and the reception unit 49. The image forming device 110 includes the control unit 50 and the ultrasonic detection device 70 similar to that in the above-described embodiments. The ultrasonic detection device 70 includes the ultrasonic transmission element 61A and the ultrasonic reception element 61B shown in FIG. 5, and the control circuit 80. The ultrasonic detection device 70 further includes the transmission circuit 71, the power supply circuit 72, and the reception circuit 73. The conveyance device 118 may include the ultrasonic detection device 70. The control circuit 80 generates a DC voltage to be applied to the ultrasonic reception element 61B constituting the reception unit 49. The control circuit 80 may have the configuration of the first embodiment or the configuration of the second embodiment. As shown in FIG. 14, the image forming device 110 may be a multifunction peripheral including an image reading device 130 at an upper portion of the main body 112. The image reading device 130 includes a feed tray 131 on which documents can be placed, and an automatic document feeder (ADF) 132 that conveys the documents on the feed tray 131 one by one.

The image reading device 130 of a sheet feed type provided at the upper portion of the main body 112 of the image forming device 110 which is a multifunction peripheral shown in FIG. 14 may include the ultrasonic detection device 70 shown in each embodiment and FIG. 14. The image reading device 130 has basically the same configuration as the image reading device 11 in each of the above-described embodiments. The image reading device 130 includes a conveyance device that conveys a document, which is an example of a medium, along a conveyance path, and an image reading unit that reads an image of the document conveyed along the conveyance path. The image reading device 130 includes the medium sensor 46 located upstream of the image reading unit in the conveyance path, and the ultrasonic sensor 47 located upstream of the medium sensor in the conveyance path. The image forming device 110 may not include the ultrasonic detection device 70 at the main body 112 that forms an image on the medium M, and only the image reading device 130 may include the ultrasonic detection device 70. On the other hand, the ultrasonic detection device 70 may be provided only at the main body 112, and the ultrasonic detection device 70 may not be provided at the image reading device 130.

The image reading device 11 may include the conveyance device 30 shown in FIG. 15. The image reading device 11 includes a first medium sensor 101 and a second medium sensor 102. Since the configuration other than the first medium sensor 101 and the second medium sensor 102 is the same as the configuration of the image reading device 11 shown in FIG. 2, description of the other configuration will be omitted. The image reading device 11 includes the conveyance device 30, the image reading unit 40 (see FIG. 2) which is an example of an image processing unit, the first medium sensor 101, the ultrasonic sensor 47, and the second medium sensor 102. The first medium sensor, which is located upstream of the image reading unit 40 in the conveyance path and detects the presence or absence of a medium ,and the ultrasonic sensor 47, which is located upstream of the first medium sensor 101 in the conveyance path 29, include the ultrasonic transmission element 61A and the ultrasonic reception element 61B that face each other across the conveyance path 29. The ultrasonic transmission element 61A is provided in the transmission unit 48, and the ultrasonic reception element 61B is provided in the reception unit 49. The second medium sensor 102 is located upstream of the ultrasonic sensor 47 in the conveyance path 29 and detects the presence or absence of the document 14 which is an example of a medium. When a detection result of the first medium sensor 101 indicates the presence of the document 14, the control unit 50 causes the ultrasonic reception element 61B to receive an ultrasonic wave in the reception drive mode in which the first DC voltage J1, which is obtained by applying an electric field of a first electric field intensity to the ultrasonic reception element 61B, is applied to the ultrasonic reception element 61B. When the detection result of the second medium sensor 102 indicates the absence of the document 14, the control unit 50 performs the reverse electric field drive mode in which the second DC voltage F1, which is obtained by applying an electric field in a direction reverse to a direction of the electric field in the reception drive mode to the ultrasonic reception element 61B, is applied to the ultrasonic reception element 61B. Instead of the reverse electric field drive mode, a high electric field drive mode may be performed. That is, when a detection result of the second medium sensor 102 indicates the absence of the document 14, the control unit 50 may perform the high electric field drive mode in which the second DC voltage J2, which is obtained by applying an electric field higher than the electric field in the reception drive mode to the ultrasonic reception element 61B, is applied to the ultrasonic reception element 61B.

The plurality of documents 14 placed on the document support 13 are introduced into the conveyance path 29 one by one. At this time, an output of the second medium sensor 102 is turned on. The document 14 introduced into the conveyance path 29 reaches a position of the second medium sensor 102 via the feeding roller 33. At this time, a leading end of the document 14 is detected by the second medium sensor 102. The output of the second medium sensor 102 indicates the presence of the document 14. The document 14 is further conveyed and reaches a position of the ultrasonic sensor 47. At this time, a detection result of the first medium sensor 101 indicates the absence of the document 14.

The document 14 that reached the position of the ultrasonic sensor 47 further advances and reaches a position of the first medium sensor 101. At this time, the leading end of the document 14 is detected by the first medium sensor 101.

At this time, the detection result of the first medium sensor 101 indicates the presence of the document 14. The reception drive shown in FIG. 10 is switched from the reverse electric field drive mode to the reception drive mode based on a detection result of the first medium sensor 101 indicating switching from the absence to the presence of the document 14. Next, a transmission period of the transmission drive starts after the elapse of the time T9. When the transmission period starts, detection by the ultrasonic sensor 47 is performed. When the ultrasonic sensor 47 detects multiple feeding, the conveyance of the document 14 is stopped before the document 14 reaches the image reading unit 40. When the multiple feeding is not detected and the conveyance of the document 14 proceeds, a trailing end of the document 14 shown in FIG. 15 is detected by the second medium sensor 102. At this time, a detection result of the second medium sensor 102 is switched from the absence to the presence of the document 14. A non-transmission period of the transmission drive starts based on a detection result of the second medium sensor 102 indicating switching from the absence to the presence of the document 14. Next, the reception drive mode is switched from the reception drive mode to the reverse electric field drive mode after the elapse of the time T8. According to this configuration, since the second medium sensor 102 is located upstream of the first medium sensor 101, it is possible to advance the start of the reverse electric field drive mode as compared with the above-described embodiments. Further, a state of the document 14 can be detected in the entire region from the leading end to the trailing end of one document 14. Instead of the reverse electric field drive mode, the high electric field drive mode may be performed using the control circuit 80 (80A) in the first embodiment.

The control and the configuration including the first medium sensor 101 and the second medium sensor 102 in the image reading device 11 shown in FIG. 15 may be applied to the image forming device 110 shown in FIG. 14.

In each of the embodiments and the modifications, the booster circuit 81 or the step-down circuit 91 may include a plurality of the capacitors C1. In this case, the plurality of capacitors C1 may be coupled in parallel between the input point A and the output point B or between the input point A and the output point C. Capacitances of the plurality of capacitors C1 may be the same or different.

In the first embodiment, the first rectangular wave SW1 of the predetermined frequency f1 having a potential equal to or lower than the power supply voltage VE is applied to the input point A which is one of the coupling points on both sides of the capacitor C1, but the first waveform may not be a rectangular wave of the predetermined frequency f1. The potential of the input point A may be a periodic wave other than the rectangular wave. The predetermined frequency f1 is not limited to a value within a range of 1 kHz to 1000 kHz, and may be a value less than 1 kHz including 10 Hz or 100 Hz.

In the first embodiment, the first rectangular wave SW1 of the predetermined frequency f1 having the first potential lower than the power supply voltage VE is generated at the input point A which is one of the coupling points on both sides of the capacitor C1, but a waveform for applying the first potential may not be a rectangular wave of the predetermined frequency f1. Switching from the first potential (for example, resistor divided voltage) of the input point A to the third potential (for example, the power supply voltage VE) according to the control signal S1 may be performed once. In this case, when a DC voltage is obtained from the output point B instead of a rectangular wave, the rectifier circuit 84 may be omitted.

In the second embodiment, the first rectangular wave SW1 of the predetermined frequency f1 having the first potential lower than the power supply voltage VE is generated at the input point A which is one of the coupling points on both sides of the capacitor C1, but a waveform for applying the first potential may not be a rectangular wave of the predetermined frequency f1. Switching from the first potential (for example, the power supply voltage VE) of the input point A to the third potential (for example, resistor divided voltage) according to the control signal S1 may be performed once. In this case, when a DC voltage is obtained from the output point B instead of a rectangular wave, the rectifier circuit 94 may be omitted.

In the second embodiment, the reference voltage Vo is not limited to the ground voltage Vgrd.

The reference voltage Vo may be a ground voltage. The reference voltage Vo may be a negative voltage. For example, in the image forming device 110, the reference voltage Vo may be a low-potential-side reference voltage used for ejection drive control of the ejection head 116. In this case, the control circuit 80 (80B) generates a negative DC voltage lower than the reference voltage Vo (< 0) as the second DC voltage F1.

The time TH and the time TR may be less than one second or one second or more. For example, the time may be 1second or more and 5 seconds or less, or 10 seconds or more and 30 seconds or less.

In the embodiments described above, a period in which the second DC voltage J2 or F1 is applied to the ultrasonic reception element 61B is not limited to the non-transmission period. The second DC voltage J2 or F1 may be applied to the ultrasonic reception element 61B in the transmission period or in a period including a part of the transmission period.

The DC voltage Vd generated by the control circuit 80 is not limited to the first DC voltage J1 and the second DC voltage J2 or F1. The DC voltage Vd may be three or more types including the first DC voltage J1 and the second DC voltage J2 or F1.

The control circuit 80 (the first control circuit 80A) of the first embodiment and the control circuit 80 (the second control circuit 80B) of the second embodiment may be used in combination. That is, the second DC voltage J2 generated by the first control circuit 80A is applied to the ultrasonic reception element 61B in the high electric field drive mode, the first DC voltage J1 generated by the first control circuit 80A or the second control circuit 80B is applied to the ultrasonic reception element 61B in the reception drive mode, and further the second DC voltage F1 generated by the second control circuit 80B is applied to the ultrasonic reception element 61B in the low electric field drive mode. In this case, one of the first control circuit 80A and the second control circuit 80B may not include the first voltage generation circuit CA1 or CB1.

In the first embodiment, the same control as in the second embodiment may be performed. That is, the conveyance unit 31 conveys the documents 14 one by one. The control unit 50 that controls the control circuit 80 causes the ultrasonic sensor 47 to execute the multiple feeding detection processing of detecting multiple feeding of the documents 14. The control unit 50 controls the control circuit 80 (80A) to generate the second DC voltage J2 within a period in which the ultrasonic sensor detects a gap between the preceding document 14 (preceding medium) conveyed first from the conveyance unit 31 and the subsequent document 14 (subsequent medium) conveyed subsequent to the preceding document 14. Accordingly, the control unit 50 performs the high electric field drive mode during the period.

The first voltage generation circuit and the second voltage generation circuit may be coupled in parallel, and respective output voltages may be switched and applied to the ultrasonic reception element 61B. In this case, the low-pass filter circuits 86 and 96 are provided.

The control circuit 80 may be mounted on a substrate portion different from the substrate main body portion 63 constituting the ultrasonic reception element 61B, or may be mounted on a substrate portion common to the ultrasonic reception element by being mounted on the substrate main body portion 63. The control circuit 80 may be mounted on a substrate portion different from a substrate portion constituting the power supply circuit 72, or may be mounted on a substrate portion common to the substrate portion constituting the power supply circuit 72.

The switching elements Q1, Q3, and Q4 and the changeover switch Q2 in the control circuit 80 (80A, 80B) are not limited to bipolar transistors, and may be field-effect transistors or insulated gate bipolar transistors.

A supply voltage of a power supply adapter may be supplied to the control circuit 80 without passing through the power supply circuit 72. In this manner, the power supply adapter may be an example of a power supply.

The image forming device 110 is not limited to a multifunction peripheral, and may not include the image reading device 130.

The image forming device 110 may be a so-called consumer printer used as a home printer, or a business printer used in an office or the like. The image forming device 110 is not limited to an inkjet printer, and may be an electrophotographic printer such as a laser printer that performs printing on the medium M using toner as ink. The image forming device 110 may be a textile printer that performs printing on a medium M that is fabric, or a printer that performs printing on a material such as a T-shirt serving as the medium M. The image forming device 110 may be a printer that performs printing on a transfer film capable of transferring an image by a direct to film (DTF) method, which serves as the medium M. The image forming device 110, which is an inkjet printer, prints characters or images by ejecting ink, which is an example of a recording material, toward the medium M. The image forming device 110 is also a liquid ejection device that ejects a liquid such as ink toward a medium such as paper.

The image reading device 11 is not limited to a sheet feed type, and may also be a flatbed type. The flatbed type image reading device includes a carriage movable along the sub scanning direction Y1 in a main body. The carriage includes a light source and a reading unit. The image sensor 42 constituting the reading unit is disposed at the carriage such that an arrangement direction of light reception elements is parallel to the main scanning direction X1. The carriage reciprocates in the sub scanning direction Y1 using a scanning motor as a power source. An image of the document 14 set on a glass plate of a document table is read by the light source and the reading unit that move together with the carriage.

When the ultrasonic sensor 47 is a transmission type, the ultrasonic sensor 47 is not limited to a sensor that detects multiple feeding of media.

The ultrasonic sensor 47 of a transmission type may detect a thickness of a medium, or may detect a type of a medium based on a difference in the thickness of the medium.

The ultrasonic sensor 47 is not limited to a transmission type, and may be a reflection type. The ultrasonic sensor of a reflection type may be a distance sensor that measures a distance. The distance sensor may be used as a liquid level sensor that detects a distance to a liquid level or a medium remaining amount sensor that detects a height of a surface of an uppermost medium among stacked media. The ultrasonic sensor of a reflection type may use the Doppler effect.

For example, in the image forming device 110, the liquid level sensor may detect a liquid level of ink in a liquid container such as a tank that contains ink, which is an example of a liquid to be supplied to the ejection head 116 of the image forming unit 115. In this case, a remaining amount of ink may be detected or an ink near end or an ink end may be detected based on a liquid level height detected by the liquid level sensor.

The ultrasonic transmission element and the ultrasonic reception element are not limited to having a common configuration, and may have different configurations.

The image sensor 42 is not limited to a CMOS image sensor, and may be a metal oxide semiconductor (MOS) image sensor, or a charge coupled device (CCD) image sensor.

The image sensor 42 is not limited to a linear image sensor, and may be an area image sensor.

Functional units of a computer including the control unit 50 are not limited to being implemented by a CPU, and may be implemented by hardware with an electronic circuit such as an application specific integrated circuit (ASIC) or a field programmable gate array (FPGA), or may be implemented by both of software and hardware.

The control circuit 80, the ultrasonic detection device, and the conveyance device may be applied to an image processing device other than the image reading device 11 and the image forming device 110.

A material of the medium is not limited to paper, and may be a resin film, a sheet, woven fabric, a metal film, or the like.

### Definitions

The expression "at least one" used in the present specification refers to "one or more" of desired options. For example, the expression "at least one" used in the present specification refers to "only one option" or "both of two options" when the number of options is two. As another example, the expression "at least one" used in the present specification refers to "only one option" or "a combination of any two or more options" when the number of options is three or more.

### Technical Ideas

Hereinafter, the technical ideas grasped from the embodiments and modifications described above will be described together with effects.

[1] A control circuit in an ultrasonic detection device is a control circuit that is provided in the ultrasonic detection device including an ultrasonic transmission element configured to transmit an ultrasonic wave and a piezoelectric ultrasonic reception element configured to receive an ultrasonic wave, and that controls a power supply voltage supplied from a power supply to switch a DC voltage to be applied to the ultrasonic reception element. The control circuit includes: a first voltage generation circuit configured to generate a first DC voltage equal to or lower than the power supply voltage; a second voltage generation circuit configured to generate a second DC voltage higher than the power supply voltage; and a changeover switch configured to switch one of the first voltage generation circuit and the second voltage generation circuit as an effective circuit that generates the DC voltage, in which the second voltage generation circuit includes a booster circuit that boosts the power supply voltage to the second DC voltage, and the booster circuit includes a capacitor that accumulates charges for boosting when the second voltage generation circuit is switched to be effective, and boosts the power supply voltage to the second DC voltage using a potential difference between both sides of the capacitor.

According to this configuration, the first DC voltage equal to or lower than the power supply voltage and the second DC voltage higher than the power supply voltage VE can be generated as the DC voltage Vd to be applied to the ultrasonic reception element with a simple circuit configuration. Therefore, even with a low power supply voltage that is lower than the second DC voltage, the second DC voltage higher than the power supply voltage can be generated with a simple circuit configuration. For example, a decrease in sensitivity of the ultrasonic reception element can be reduced by performing the high electric field drive mode in which the second DC voltage is applied to the ultrasonic reception element.

[2] In the control circuit in the ultrasonic detection device according to the above [1], the ultrasonic reception element may include a piezoelectric element stacked on a vibration plate, the piezoelectric element may include a first electrode, a second electrode facing the first electrode, and a piezoelectric body interposed between the first electrode and the second electrode, the control circuit may drive the piezoelectric element in a reception drive mode in which the first DC voltage, which is obtained by applying an electric field of a first electric field intensity to the piezoelectric body, is applied between the first electrode and the second electrode when the ultrasonic reception element receives the ultrasonic wave, and the control circuit may drive the piezoelectric element in a high electric field drive mode in which the second DC voltage, which is obtained by applying an electric field of a second electric field intensity higher than the first electric field intensity to the piezoelectric body, is applied between the first electrode and the second electrode before the reception drive mode is performed. According to this configuration, the piezoelectric element can be driven in the high electric field drive mode in which the second DC voltage higher than the power supply voltage is applied to the piezoelectric element without using the power supply voltage equal to or higher than the second DC voltage.

Therefore, it is possible to prevent a decrease in sensitivity of the ultrasonic reception element with a low power supply voltage and a simple circuit configuration.

[3] In the control circuit in the ultrasonic detection device according to the above [1] or [2], the booster circuit may charge the capacitor by applying a positive first potential lower than the power supply voltage to an input point which is one of coupling points on both sides of the capacitor and applying a second potential higher than the first potential and equal to or lower than the power supply voltage to an output point which is the other one of the coupling points on both sides of the capacitor, and generate the second DC voltage by switching the first potential of the input point to a third potential higher than the first potential and equal to or lower than the power supply voltage after the capacitor is charged and by boosting the second potential of the output point to a fourth potential obtained by adding a potential difference between both sides of the charged capacitor to the second potential. According to this configuration, it is possible to reduce a decrease in sensitivity of the ultrasonic reception element with a simple circuit configuration even at a low power supply voltage lower than the second DC voltage.

[4] In the control circuit in the ultrasonic detection device according to any one of the above [1] to [3], the booster circuit may include a rectangular wave generation circuit configured to generate a first rectangular wave having an amplitude equal to or lower than the power supply voltage, a shift-up circuit configured to generate a second rectangular wave obtained by shifting up a voltage level of the first rectangular wave, and a rectifier circuit configured to rectify the second rectangular wave, and the shift-up circuit may include the capacitor coupled between an input point that receives the first rectangular wave and an output point that outputs the second rectangular wave.

According to this configuration, since the second rectangular wave is generated by shifting up the voltage level of the first rectangular wave using a voltage based on the charges accumulated in the capacitor, the second DC voltage can be generated by rectifying the second rectangular wave. Therefore, the first DC voltage equal to or lower than the power supply voltage and the second DC voltage higher than the power supply voltage can be applied to the piezoelectric element with a simple circuit configuration. The second DC voltage can also be applied to the ultrasonic reception element with a simple circuit configuration at a low power supply voltage lower than the second DC voltage. For example, a decrease in sensitivity of the ultrasonic reception element can be reduced.

[5] In the control circuit in the ultrasonic detection device according to the above [4], the rectangular wave generation circuit may include a plurality of resistors that divide the power supply voltage at the input point, and an amplitude of the first rectangular wave may be determined by a resistor divided voltage at the input point. According to this configuration, a voltage for boosting the power supply voltage to the second DC voltage can be controlled by adjusting the resistor divided voltage at the input point where the power supply voltage is divided by the plurality of resistors. Therefore, the generated second DC voltage can be determined with a simple configuration. For example, a circuit is easily designed.

[6] The control circuit in the ultrasonic detection device according to the above [5] may include: a first line coupled to a power supply line to which the power supply voltage is supplied and on which the plurality of resistors and the input point are located; and a second line coupled to the power supply line and through which the power supply voltage is applied to the output point, in which the second line may be provided with a diode whose forward direction is a direction toward the output point. According to this configuration, since the charges once accumulated in the capacitor are less likely to be discharged, a voltage can be quickly boosted. Even after the supply of the power supply voltage is stopped, a state in which the second DC voltage is applied to the ultrasonic reception element can be maintained.

[7] In the control circuit in the ultrasonic detection device according to the above [6], the rectangular wave generation circuit may include a switching element coupled to the first line, the first rectangular wave may be generated by turning on and off the switching element at a predetermined frequency, and the shift-up circuit may perform shift-up by charging the capacitor by a potential difference between an input potential of the input point when the switching element is turned on and an output potential of the output point when the switching element is turned on. According to this configuration, the first rectangular wave can be generated by the control of turning on or off the switching element at the predetermined frequency, and the first rectangular wave can be shifted up to the second rectangular wave by charging the capacitor provided in the shift-up circuit. Therefore, the second DC voltage higher than the power supply voltage can be generated with a simple circuit configuration.

[8] In the control circuit in the ultrasonic detection device according to any one of the above [1] to [7], a magnitude relationship of Vo < J1 < VE < J2 is satisfied, in which Vo is a reference voltage, J1 is the first DC voltage, VE is the power supply voltage, and J2 is the second DC voltage. According to this configuration, the first DC voltage J1 higher than the ground voltage Vgrd (for example, 0 V) and lower than the power supply voltage and the second DC voltage J2 higher than the power supply voltage VE can be switched and applied to the ultrasonic reception element. It is not necessary to provide a power supply having a power supply voltage equal to or higher than the second DC voltage.

[9] A control circuit in an ultrasonic detection device is a control circuit that is provided in the ultrasonic detection device including an ultrasonic transmission element configured to transmit an ultrasonic wave and a piezoelectric ultrasonic reception element configured to receive an ultrasonic wave, and that controls a power supply voltage supplied from a power supply to switch a DC voltage to be applied to the ultrasonic reception element. The control circuit includes: a first voltage generation circuit configured to generate a first DC voltage equal to or lower than the power supply voltage at a detection period when the ultrasonic reception element receives the ultrasonic wave; a second voltage generation circuit configured to generate a negative second DC voltage lower than a reference voltage of the power supply at a non-detection period when the ultrasonic reception element does not receive the ultrasonic wave; and a changeover switch configured to switch one of the first voltage generation circuit and the second voltage generation circuit as an effective circuit that generates the DC voltage, in which the second voltage generation circuit includes a step-down circuit that steps down the power supply voltage to the second DC voltage, and the step-down circuit includes a capacitor that accumulates charges for step-down when the second voltage generation circuit is switched to be effective, and steps down the reference voltage to the second DC voltage using a potential difference between both sides of the capacitor. According to this configuration, the first DC voltage higher than the reference voltage and equal to or lower than the power supply voltage and the second DC voltage lower than the reference voltage (for example, the ground voltage) can be generated as the DC voltage to be applied to the ultrasonic reception element with a simple circuit configuration.

In the control circuit in the ultrasonic detection device according to the above [9], the ultrasonic reception element may include a piezoelectric element stacked on a vibration plate, the piezoelectric element may include a first electrode, a second electrode facing the first electrode, and a piezoelectric body interposed between the first electrode and the second electrode, the control circuit may drive the piezoelectric element in a reception drive mode in which the first DC voltage, which is obtained by applying an electric field of a first electric field intensity to the piezoelectric body, is applied between the first electrode and the second electrode when the ultrasonic reception element receives the ultrasonic wave, and the control circuit may drive the piezoelectric element in a reverse electric field drive mode in which the second DC voltage, which is obtained by applying an electric field in a direction reverse to a direction of the electric field in the reception drive mode to the piezoelectric body, is applied between the first electrode and the second electrode when the ultrasonic reception element does not receive the ultrasonic wave.

According to this configuration, when the ultrasonic reception element does not receive the ultrasonic wave, the second DC voltage, which is obtained by applying the electric field in a direction reverse to the direction of the electric field in the reception drive mode to the piezoelectric body, is applied between the first electrode and the second electrode. Therefore, it is possible to reduce a decrease in sensitivity of the ultrasonic reception element without affecting the reception of the ultrasonic wave by the ultrasonic reception element.

In the control circuit in the ultrasonic detection device according to the above [9] or , the step-down circuit may charge the capacitor by applying a first potential equal to or lower than the power supply voltage and higher than the reference voltage to an input point which is one of coupling points both sides of the capacitor and applying a second potential lower than the first potential and equal to or higher than the reference voltage to an output point which is the other one of the coupling points on both sides of the capacitor, and generate the second DC voltage by switching the first potential of the input point to a third potential lower than the first potential and equal to or higher than the reference voltage after the capacitor is charged and by stepping down the second potential of the output point to a fourth potential obtained by subtracting a voltage of a potential difference between both sides of the charged capacitor from the second potential. According to this configuration, it is possible to reduce a decrease in sensitivity of the ultrasonic reception element with a simple circuit configuration without preparing the reference voltage equal to or lower than the second DC voltage which is a negative voltage.

In the control circuit in the ultrasonic detection device according to any one of the above [9] to , the step-down circuit may include a rectangular wave generation circuit configured to generate a first rectangular wave having an amplitude equal to or lower than the power supply voltage, a shift-down circuit configured to generate a second rectangular wave obtained by shifting down a voltage level of the first rectangular wave, and a rectifier circuit configured to rectify the second rectangular wave, and the shift-down circuit may include the capacitor coupled between an input point that receives the first rectangular wave and an output point that outputs the second rectangular wave.

According to this configuration, since the second rectangular wave is generated by shifting down the voltage level of the first rectangular wave using a voltage based on the charges accumulated in the capacitor, the second DC voltage can be generated by rectifying the second rectangular wave. Therefore, the first DC voltage equal to or lower than the power supply voltage and the second DC voltage higher than the power supply voltage can be applied to the ultrasonic reception element with a simple circuit configuration. The second DC voltage can also be applied to the ultrasonic reception element with a simple circuit configuration at a power supply voltage higher than the second DC voltage. Therefore, a reverse electric field in a direction reverse to a direction of an electric field at the time of reception can be applied to the ultrasonic reception element. For example, a decrease in sensitivity of the ultrasonic reception element can be reduced.

In the control circuit in the ultrasonic detection device according to the above , the rectangular wave generation circuit may include a plurality of resistors that divide the power supply voltage at the input point, and an amplitude of the first rectangular wave may be determined by a resistor divided voltage at the input point. According to this configuration, a step-down voltage for stepping down the reference voltage to the second DC voltage can be controlled by adjusting the resistor divided voltage at the input point where the power supply voltage is divided by the plurality of resistors. Therefore, the generated second DC voltage can be determined with a simple configuration. For example, a circuit is easily designed.

The control circuit in the ultrasonic detection device according to any one of the above [9] to may include: a first line coupled to a power supply line to which the power supply voltage is supplied and on which the plurality of resistors and the input point are located in series; and a second line through which the reference voltage is applied to the output point, in which the second line is provided with a diode whose forward direction is a direction toward the output point. According to this configuration, charges temporarily accumulated in the capacitor are prevented from being discharged to the ground or the like by the diode. Therefore, a voltage can be quickly stepped down. For example, even when a drive time of the second voltage generation circuit is short, a sufficient reverse electric field can be applied to the ultrasonic reception element by applying the second DC voltage lower than the reference voltage Vo.

In the control circuit in the ultrasonic detection device according to the above , the rectangular wave generation circuit may include a switching element coupled to the first line, and generate the first rectangular wave by turning on and off the switching element at a predetermined frequency, and the shift-down circuit may perform shift-down by charging the capacitor by a potential difference between an output potential of the output point when the switching element is turned on and an input potential of the input point when the switching element is turned on. According to this configuration, the first rectangular wave can be generated by the control of turning on or off the switching element at the predetermined frequency, and the first rectangular wave can be shifted down to the second rectangular wave by charging the capacitor provided in the shift-down circuit. Therefore, the second DC voltage lower than the reference voltage can be generated with a simple circuit configuration.

In the control circuit in the ultrasonic detection device according to any one of the above [9] to , a magnitude relationship of F1 < Vgrd < J1 < VE may be satisfied, in which a ground voltage Vgrd is the reference voltage, J1 is the first DC voltage, VE is the power supply voltage, and F1 is the second DC voltage. According to this configuration, the first DC voltage J1 and the negative second DC voltage F1 lower than the ground voltage Vgrd (for example, 0 V) can be switched and applied to the ultrasonic reception element.

An ultrasonic detection device includes: the control circuit according to any one of the above [1] to ; the ultrasonic transmission element; and the ultrasonic reception element. According to this configuration, it is possible to reduce a decrease in sensitivity of the ultrasonic reception element with a simple circuit configuration.

A conveyance device includes: the control circuit according to any one of the above [1] to ; a conveyance unit configured to convey a medium along a conveyance path; a control unit configured to control the control circuit and the conveyance unit; and an ultrasonic sensor including the ultrasonic transmission element and the ultrasonic reception element that are disposed to face each other across the conveyance path. According to this configuration, when the medium conveyed along the conveyance path is detected by the ultrasonic sensor, it is possible to reduce a decrease in sensitivity of the ultrasonic sensor with a simple circuit configuration.

An image processing device may include: the conveyance device according to the above ; an image processing unit configured to execute processing related to an image on the medium conveyed along the conveyance path; and a medium sensor provided upstream of the image processing unit in the conveyance path and configured to detect the medium conveyed along the conveyance path, in which the ultrasonic sensor may be located upstream of the medium sensor in the conveyance path. According to this configuration, multiple feeding of the medium can be detected at a position upstream of the medium sensor in the conveyance path. The multiple feeding can be detected at an early stage after the conveyance of the medium is started. The multiple feeding of the medium can be detected before the multiple fed media reach a position of the medium sensor.

In the image processing device according to the above , the conveyance unit may convey the medium one by one, and the control unit may be configured to cause the ultrasonic sensor to execute multiple feeding detection processing of detecting multiple feeding of the medium, and control the control circuit to generate the second DC voltage within a period in which the ultrasonic sensor detects a gap between a preceding medium which is the medium conveyed first from the conveyance unit and a subsequent medium which is the medium conveyed subsequent to the preceding medium. According to this configuration, since the reverse second DC voltage is applied within the period in which the gap between the preceding medium and the subsequent medium is detected, it is possible to perform multiple feeding detection of the medium while reducing a decrease in sensitivity.

An image processing device includes: the conveyance device according to the above ; an image processing unit configured to execute processing related to an image on the medium conveyed along the conveyance path; a first medium sensor located upstream of the image processing unit in the conveyance path and configured to detect presence or absence of the medium; an ultrasonic sensor located upstream of the first medium sensor in the conveyance path and including the ultrasonic transmission element and the ultrasonic reception element that face each other across the conveyance path; and a second medium sensor located upstream of the ultrasonic sensor in the conveyance path and configured to detect presence or absence of the medium, in which the control unit is configured to cause the ultrasonic reception element to receive the ultrasonic wave in a reception drive mode in which the first DC voltage, which is obtained by applying an electric field of a first electric field intensity, is applied to the ultrasonic reception element when a detection result of the first medium sensor indicates the presence of the medium, and perform a reverse electric field drive mode in which the second DC voltage, which is obtained by applying an electric field in a direction reverse to a direction of the electric field in the reception drive mode to the ultrasonic reception element, is applied to the ultrasonic reception element when a detection result of the second medium sensor indicates the absence of the medium. According to this configuration, the reception drive mode and the reverse electric field drive mode can be switched based on detection results of the first medium sensor and the second medium sensor located upstream and downstream of the ultrasonic sensor 47 in the conveyance path 29. Therefore, the reception drive mode and the reverse electric field drive mode can be switched at an appropriate timing according to a conveyance position of the medium.

A voltage control method of an ultrasonic reception element is a voltage control method of controlling a power supply voltage supplied from a power supply to switch a DC voltage to be applied to the ultrasonic reception element in an ultrasonic detection device including an ultrasonic transmission element that transmits an ultrasonic wave and the ultrasonic reception element that receives an ultrasonic wave. The voltage control method of the ultrasonic reception element includes: (A1) generating a first DC voltage equal to or lower than the power supply voltage in a detection period in which the ultrasonic reception element receives the ultrasonic wave; and (A2) generating a second DC voltage higher than the power supply voltage in a non-detection period in which the ultrasonic reception element does not receive the ultrasonic wave, in which the generation of the second DC voltage includes (A21) generating a first rectangular wave having an amplitude equal to or lower than the power supply voltage, (A22) generating a second rectangular wave obtained by shifting up a voltage level of the first rectangular wave, and (A23) rectifying the second rectangular wave, and the shift-up is performed based on a potential difference caused by charges accumulated in a capacitor coupled between an input point that receives the first rectangular wave and an output point that outputs the second rectangular wave. According to this method, the second DC voltage higher than the power supply voltage can be generated with a simple circuit configuration. Therefore, even with a low power supply voltage that is lower than the second DC voltage, the second DC voltage higher than the power supply voltage can be generated with a simple circuit configuration. For example, a decrease in sensitivity of the ultrasonic reception element can be reduced by performing the high electric field drive mode in which the second DC voltage is applied to the ultrasonic reception element.

A voltage control method of an ultrasonic reception element is a voltage control method of controlling a power supply voltage supplied from a power supply to switch a DC voltage to be applied to the ultrasonic reception element in an ultrasonic detection device including an ultrasonic transmission element that transmits an ultrasonic wave and the ultrasonic reception element that receives an ultrasonic wave. The voltage control method of the ultrasonic reception element includes: (B1) generating a first DC voltage equal to or lower than the power supply voltage in a detection period in which the ultrasonic reception element receives the ultrasonic wave; and (B2) generating a negative second DC voltage lower than a reference voltage which is a low-potential-side voltage of the power supply in a non-detection period in which the ultrasonic reception element does not receive the ultrasonic wave, in which the generation of the second DC voltage includes (B21) generating a first rectangular wave having an amplitude equal to or lower than the power supply voltage, (B22) generating a second rectangular wave obtained by shifting down a voltage level of the first rectangular wave, and (B23) rectifying the second rectangular wave, and the shift-down is performed based on a potential difference caused by charges accumulated in a capacitor coupled between an input point that receives the first rectangular wave and an output point that outputs the second rectangular wave. According to this method, the first DC voltage equal to or lower than the power supply voltage and the negative second DC voltage lower than the reference voltage Vo (for example, the ground voltage Vgrd) of a power supply can be generated as a DC voltage to be applied to the ultrasonic reception element with a simple circuit configuration.

What is claimed is:

1. A control circuit in an ultrasonic detection device that is a control circuit provided in the ultrasonic detection device including an ultrasonic transmission element configured to transmit an ultrasonic wave and a piezoelectric ultrasonic reception element configured to receive an ultrasonic wave, and that controls a power supply voltage supplied from a power supply to switch a DC voltage to be applied to the ultrasonic reception element, the control circuit comprising:
a first voltage generation circuit configured to generate a first DC voltage equal to or lower than the power supply voltage;
a second voltage generation circuit configured to generate a second DC voltage higher than the power supply voltage; and
a changeover switch configured to switch one of the first voltage generation circuit and the second voltage generation circuit as an effective circuit that generates the DC voltage, wherein
the second voltage generation circuit includes a booster circuit that boosts the power supply voltage to the second DC voltage, and
the booster circuit includes a capacitor that accumulates charges for boosting when the second voltage generation circuit is switched to be effective, and boosts the power supply voltage to the second DC voltage using a potential difference between both sides of the capacitor.

2. The control circuit in the ultrasonic detection device according to claim 1, wherein
the ultrasonic reception element includes a piezoelectric element stacked on a vibration plate,
the piezoelectric element includes a first electrode, a second electrode facing the first electrode, and a piezoelectric body interposed between the first electrode and the second electrode,
the control circuit drives the piezoelectric element in a reception drive mode in which the first DC voltage, which is obtained by applying an electric field of a first electric field intensity to the piezoelectric body, is applied between the first electrode and the second electrode when the ultrasonic reception element receives the ultrasonic wave, and
the control circuit drives the piezoelectric element in a high electric field drive mode in which the second DC voltage, which is obtained by applying an electric field of a second electric field intensity higher than the first electric field intensity to the piezoelectric body, is applied between the first electrode and the second electrode before the reception drive mode is performed.

3. The control circuit in the ultrasonic detection device according to claim 1, wherein
the booster circuit charges the capacitor by applying a positive first potential lower than the power supply voltage to an input point which is one of coupling points on both sides of the capacitor and applying a second potential higher than the first potential and equal to or lower than the power supply voltage to an output point which is the other one of the coupling points on both sides of the capacitor, and generates the second DC voltage by switching the first potential of the input point to a third potential higher than the first potential and equal to or lower than the power supply voltage after the capacitor is charged and by boosting the second potential of the output point to a fourth potential obtained by adding a potential difference between both sides of the charged capacitor to the second potential.

4. The control circuit in the ultrasonic detection device according to claim 1, wherein
the booster circuit includes
a rectangular wave generation circuit configured to generate a first rectangular wave having an amplitude equal to or lower than the power supply voltage,
a shift-up circuit configured to generate a second rectangular wave obtained by shifting up a voltage level of the first rectangular wave, and
a rectifier circuit configured to rectify the second rectangular wave, and
the shift-up circuit includes the capacitor coupled between an input point that receives the first rectangular wave and an output point that outputs the second rectangular wave.

5. The control circuit in the ultrasonic detection device according to claim 4, wherein
the rectangular wave generation circuit includes a plurality of resistors that divide the power supply voltage at the input point, and
an amplitude of the first rectangular wave is determined by a resistor divided voltage at the input point.

6. The control circuit in the ultrasonic detection device according to claim 5, further comprising:
a first line coupled to a power supply line to which the power supply voltage is supplied and on which the plurality of resistors and the input point are located; and
a second line coupled to the power supply line and through which the power supply voltage is applied to the output point, wherein
the second line is provided with a diode whose forward direction is a direction toward the output point.

7. The control circuit in the ultrasonic detection device according to claim 6, wherein
the rectangular wave generation circuit includes a switching element coupled to the first line,
the first rectangular wave is generated by turning on and off the switching element at a predetermined frequency, and
the shift-up circuit performs shift-up by charging the capacitor by a potential difference between an input potential of the input point when the switching element is turned on and an output potential of the output point when the switching element is turned on.

8. The control circuit in the ultrasonic detection device according to claim 1, wherein
a magnitude relationship of Vo < J1 < VE < J2 is satisfied, in which Vo is a reference voltage, J1 is the first DC voltage, VE is the power supply voltage, and J2 is the second DC voltage.

9. A control circuit in an ultrasonic detection device that is a control circuit provided in the ultrasonic detection device including an ultrasonic transmission element configured to transmit an ultrasonic wave and a piezoelectric ultrasonic reception element configured to receive an ultrasonic wave, and that controls a power supply voltage supplied from a power supply to switch a DC voltage to be applied to the ultrasonic reception element, the control circuit comprising:
a first voltage generation circuit configured to generate a first DC voltage equal to or lower than the power supply voltage at a detection period when the ultrasonic reception element receives the ultrasonic wave;
a second voltage generation circuit configured to generate a negative second DC voltage lower than a reference voltage of the power supply at a non-detection period when the ultrasonic reception element does not receive the ultrasonic wave; and
a changeover switch configured to switch one of the first voltage generation circuit and the second voltage generation circuit as an effective circuit that generates the DC voltage, wherein
the second voltage generation circuit includes a step-down circuit that steps down the power supply voltage to the second DC voltage, and
the step-down circuit includes a capacitor that accumulates charges for step-down when the second voltage generation circuit is switched to be effective, and steps down the reference voltage to the second DC voltage using a potential difference between both sides of the capacitor.

10. The control circuit in the ultrasonic detection device according to claim 9, wherein
the ultrasonic reception element includes a piezoelectric element stacked on a vibration plate,
the piezoelectric element includes a first electrode, a second electrode facing the first electrode, and a piezoelectric body interposed between the first electrode and the second electrode,
the control circuit drives the piezoelectric element in a reception drive mode in which the first DC voltage, which is obtained by applying an electric field of a first electric field intensity to the piezoelectric body, is applied between the first electrode and the second electrode when the ultrasonic reception element receives the ultrasonic wave, and
the control circuit drives the piezoelectric element in a reverse electric field drive mode in which the second DC voltage, which is obtained by applying an electric field in a direction reverse to a direction of the electric field in the reception drive mode to the piezoelectric body, is applied between the first electrode and the second electrode when the ultrasonic reception element does not receive the ultrasonic wave.

11. The control circuit in the ultrasonic detection device according to claim 9, wherein
the step-down circuit charges the capacitor by applying a first potential equal to or lower than the power supply voltage and higher than the reference voltage to an input point which is one of coupling points on both sides of the capacitor and applying a second potential lower than the first potential and equal to or higher than the reference voltage to an output point which is the other one of the coupling points on both sides of the capacitor, and generates the second DC voltage by switching the first potential of the input point to a third potential lower than the first potential and equal to or higher than the reference voltage after the capacitor is charged and by stepping down the second potential of the output point to a fourth potential obtained by subtracting a voltage of a potential difference between both sides of the charged capacitor from the second potential.

12. The control circuit in the ultrasonic detection device according to claim 9, wherein
the step-down circuit includes
a rectangular wave generation circuit configured to generate a first rectangular wave having an amplitude equal to or lower than the power supply voltage,
a shift-down circuit configured to generate a second rectangular wave obtained by shifting down a voltage level of the first rectangular wave, and
a rectifier circuit configured to rectify the second rectangular wave, and
the shift-down circuit includes the capacitor coupled between an input point that receives the first rectangular wave and an output point that outputs the second rectangular wave.

13. The control circuit in the ultrasonic detection device according to claim 12, wherein
the rectangular wave generation circuit includes a plurality of resistors that divide the power supply voltage at the input point, and
an amplitude of the first rectangular wave is determined by a resistor divided voltage at the input point.

14. The control circuit in the ultrasonic detection device according to claim 13, further comprising:
a first line coupled to a power supply line to which the power supply voltage is supplied and on which the plurality of resistors and the input point are located in series; and
a second line through which the reference voltage is applied to the output point, wherein
the second line is provided with a diode whose forward direction is a direction toward the output point.

15. The control circuit in the ultrasonic detection device according to claim 14, wherein
the rectangular wave generation circuit includes a switching element coupled to the first line,
the first rectangular wave is generated by turning on and off the switching element at a predetermined frequency, and
the shift-down circuit performs shift-down by charging the capacitor by a potential difference between an input potential of the input point when the switching element is turned on and an output potential of the output point when the switching element is turned on.

16. The control circuit in the ultrasonic detection device according to claim 9, wherein
a magnitude relationship of F1 < Vgrd < J1 < VE is satisfied, in which a ground voltage Vgrd is the reference voltage, J1 is the first DC voltage, VE is the power supply voltage, and F1 is the second DC voltage.

17. A conveyance device comprising:
the control circuit according to claim 1;
a conveyance unit configured to convey a medium along a conveyance path;
a control unit configured to control the control circuit and the conveyance unit; and
an ultrasonic sensor including the ultrasonic transmission element and the ultrasonic reception element that are disposed to face each other across the conveyance path.

18. An image processing device comprising:
the conveyance device according to claim 17;
an image processing unit configured to execute processing related to an image on the medium conveyed along the conveyance path; and
a medium sensor provided upstream of the image processing unit in the conveyance path and configured to detect the medium conveyed along the conveyance path, wherein
the ultrasonic sensor is located upstream of the medium sensor in the conveyance path.

19. The image processing device according to claim 18, further comprising:
a control unit configured to control the control circuit, wherein
the conveyance unit conveys the medium one by one, and
the control unit is configured to
cause the ultrasonic sensor to execute multiple feeding detection processing of detecting multiple feeding of the medium, and
control the control circuit to generate the second DC voltage within a period in which the ultrasonic sensor detects a gap between a preceding medium which is the medium conveyed first from the conveyance unit and a subsequent medium which is the medium conveyed subsequent to the preceding medium.

20. An image processing device comprising:
the conveyance device according to claim 17;
an image processing unit configured to execute processing related to an image on the medium conveyed along the conveyance path;
a first medium sensor located upstream of the image processing unit in the conveyance path and configured to detect presence or absence of the medium;
an ultrasonic sensor located upstream of the first medium sensor in the conveyance path and including the ultrasonic transmission element and the ultrasonic reception element that face each other across the conveyance path; and
a second medium sensor located upstream of the ultrasonic sensor in the conveyance path and configured to detect presence or absence of the medium, wherein
the control unit is configured to
cause the ultrasonic reception element to receive the ultrasonic wave in a reception drive mode in which the first DC voltage, which is obtained by applying an electric field of a first electric field intensity to the ultrasonic reception element, is applied to the ultrasonic reception element when a detection result of the first medium sensor indicates the presence of the medium, and
perform a reverse electric field drive mode in which the second DC voltage, which is obtained by applying an electric field in a direction reverse to a direction of the electric field in the reception drive mode to the ultrasonic reception element, is applied to the ultrasonic reception element when a detection result of the second medium sensor indicates the absence of the medium.
